(19) United States
(12) Patent Application Publication
(10) Pub. No.: US 2024/0368349 A1
(43) Pub. Date: Nov. 7, 2024

(54) REPROCCESSABLE NON-ISOCYANATE POLYTHIOURETHANE NETWORKS WITH THIONOURETHANE AND DISULFIDE CROSSLINKS

(71) Applicant: Northwestern University, Evanston, IL (US)

(72) Inventors: John Mark Torkelson, Skokie, IL (US); Boran Chen, Evanston, IL (US); Yixuan Chen, Evanston, IL (US)

(21) Appl. No.: 18/653,771

(22) Filed: May 2, 2024

Related U.S. Application Data
(60) Provisional application No. 63/464,006, filed on May 4, 2023.

(51) Int. Cl. C08G 71/04; C08J 3/24

(52) U.S. Cl. CPC C08G 71/04; C08J 3/247; C08J 2375/04

(57) ABSTRACT

Disulfide-crosslinked non-isocyanate polythiourethane networks, methods of making the disulfide crosslinked non-isocyanate polythiourethane networks, and methods of reprocessing the disulfide crosslinked non-isocyanate polythiourethane networks are provided. The polymer backbone chains of the non-isocyanate polythiourethane networks include two or more thionourethane groups and inter-chain disulfide crosslinks and are branched at thionourethane linkages. The reprocessable disulfide crosslinked non-isocyanate polythiourethanes can be formed from renewable, biobased starting materials.

### CROSS-REFERENCE TO RELATED APPLICATION

The present application claims the priority benefit of U.S. Provisional Patent Application No. 63/464,006 filed on May 4, 2023, the entire disclosure of which is incorporated herein by reference.

### REFERENCE TO GOVERNMENT RIGHTS

This invention was made with government support under DE-EE0008928 awarded by the Department of Energy. The government has certain rights in the invention.

### BACKGROUND

Polyurethanes (PUs) are a versatile class of materials that are widely used in applications ranging from foams and coatings to adhesives and sealants, and even biomedical devices. Traditional PUs are synthesized from toxic isocyanates which are derived from toxic phosgene, leading to significant safety hazards and implications for human health and sustainability. To develop more environmentally friendly and healthy alternatives to PUS, research has focused on non-isocyanate polyurethanes (NIPUs) and non-isocyanate polythiourethanes (NIPTUs).

The most heavily studied NIPUs are polyhydroxyurethanes (PHUs) synthesized by aminolysis of 5-membered cyclic carbonate (CC), which can be easily synthesized by CO₂ fixation of epoxy precursors. However, the inherently low reactivity and selectivity of CCs toward amines, even in the presence of catalysts, often lead to high reaction temperature (≥80° C.) and long reaction time. Along with the low reactivity, the high density of hydrogen bonds and the presence of side reactions make it challenging to obtain PHUs with high molar masses. Finally, the hydrophilicity and compromised water resistance of PHUs can diminish their mechanical properties under many conditions. These drawbacks have impeded the commercialization of PHUs.

Moriguchi and Endo were the first to demonstrate the synthesis of NIPTU from diamines and 5-membered cyclic dithiocarbonates (DTC), the latter being produced by carbon disulfide (CS₂) fixation of epoxy precursors. (Moriguchi, T.; Endo, T. Macromolecules 1995, 28, 5386-5387.) The DTC groups react with amine groups to form thiourethane moieties that serve as linkages on the backbone. Due to their larger and more favorable ring strain, DTCs are more reactive to nucleophiles than their oxygen analogs, i.e., CCs, which enables relatively fast reactions under milder conditions. (Inoue, Y. et al., J. Polym. Sci., Part A: Polym. Chem. 2015, 53, 1076-1081; Suzuki, A. et al., J. Polym. Sci., Part A: Polym. Chem. 2004, 42, 5983-5989.) Moreover, the amine reacts with the S-C(S) bond in DTCs by regioselective nucleophilic addition, leading to an enhanced selectivity toward the formation of 100% primary thiol, unlike the reaction with CCs which often leads to 60-70% secondary hydroxyl groups. (Vanbiervliet, E. et al., Macromolecules 2019, 52, 5838-5849; Xu, B. et al., ACS Macro Lett. 2022, 11, 517-524; Suzuki, A. et al., 2004; Tomita, H. et al., Macromolecules 2001, 34, 727-733.)

A recent study reported polythionourethane synthesized from isothiocyanate and alcohol. (Wolfs, J. et al., ACS Sustain. Chem. Eng. 2023, 11, 3952-3962.) The thionourethane linkage also has the sulfur atom at the thiocarbonyl position, with a linkage structure like the linkages in what the research literature has called non-isocyanate polythiourethanes or NIPTUs since 1995. However, NIPTUs have additional primary thiol groups that distinguish them from polythionourethanes. Because the naming of these materials as non-isocyanate polythiourethanes is well established, the materials described herein are referred to as NIPTUs. However, it is acknowledged that NIPTUs contain thionourethane linkages with additional primary thiol groups. (Vanbiervliet, E. et al., Macromolecules 2019, 52, 5838-5849; Wu, S. et al., ACS Sustain. Chem. Eng. 2020, 8, 5693-5703; Xu, B. et al., ACS Macro Lett. 2022, 11, 517-524; Vanbiervliet, E. et al., Macromolecules 2017, 50, 69-82; Moriguchi, T. et al., Macromolecules 1995, 28, 5386-5387; Inoue, Y. et al., J. Polym. Sci., Part A: Polym. Chem. 2015, 53, 1076-1081; Suzuki, A. et al., J. Polym. Sci., Part A: Polym. Chem. 2004, 42, 5983-5989; Tomita, H. et al., Macromolecules 2001, 34, 727-733; Liu, W. et al., J. Polym. Sci. 2022, 60, 2756-2768; Cheng, C. et al., Iran. Polym. J. 2017, 26, 821-831; Ge, W. et al., Macromol. Rapid Commun. 2021, 42, 2000718; Motokucho, S. et al., J. Polym. Sci., Part A: Polym. Chem. 2005, 43, 3711-3717; Darensbourg, D. J. et al., Macromolecules 2013, 46, 8102-8110; Ochiai, B. et al.,Prog. Polym. Sci. 2005, 30, 183-215; Sudo, A.et al., J. Polym. Sci., Part A: Polym. Chem. 2011, 49, 1097-1103; Zhang, Y. et al., J. Polym. Sci., Part A: Polym. Chem. 2008, 46, 1907-1912; Horikiri, M. et al., J. Polym. Sci., Part A: Polym. Chem. 2007, 45, 4606-4611; Uenishi, K.et al., J. Polym. Sci., Part A: Polym. Chem. 2005, 43, 4422-4430; Besse, V. et al.,J. Polym. Sci., Part A: Polym. Chem. 2013, 51, 3284-3296.)

In view of the drive toward sustainable and green materials, there is substantial and increasing interest in exploring renewable NIPU and NIPTU materials as replacements for petroleum-based PU and PU-like materials. Numerous studies have reported on biobased PHUs synthesized or capable of being synthesized from unsaturated raw materials. However, reports on biobased NIPTUs are extremely rare. One study reports on a biobased NIPTU, which was derived from eugenol or clove oil, a compound that is widely used in the food industry. (Cheng, C. et al., Iran. Polym. J. 2017, 26, 821-831.) Many of the reported biobased precursors that have been used for NIPU synthesis are valuable in other industries, e.g., vegetable oils in the food industry. Renewable materials derived from waste sources may provide a route to develop NIPUs or NIPTUs without potentially negative economic implications for industry or the consumer. From a sustainability standpoint, the inclusion or conversion of biowaste into potentially valuable polymeric materials is highly favorable. However, no study has been published on NIPTUs synthesized from biowaste materials.

In addition to developing renewable precursors to NIPUs and NIPTUs, developing reprocessable NIPU and NIPTU networks provides another route to improve sustainability by recycling the product. Reprocessable polymer networks are commonly referred to as covalent adaptable networks (CANs) or dynamic covalent polymer networks (DCPNs); the dynamic chemistry responsible for the reprocessable character of CANs can be dissociative and/or associative in nature. When the dynamic chemistry responsible for network reprocessability is strictly associative, such network materials are also called vitrimers.

Dynamic covalent disulfide linkages in NIPTUs have been examined. Zheng and coworkers synthesized NIPTU with linear backbones, oxidized the thiol groups into inter-chain disulfide linkages using a radical initiator, and demonstrated the reprocessability of the NIPTUs in which all crosslinks were based on dynamic covalent disulfide bonds. (Liu, W. et al., J. Polym. Sci. 2022, 60, 2756-2768; Ge, W. et al., Macromol. Rapid Commun. 2021, 42, 2000718.)

### SUMMARY

NIPTU networks in which the crosslinks are of two types, thionourethane and disulfide, the latter obtained by auto-oxidation of pendant thiol groups, are provided. The auto-oxidation of the pendant thiol groups can be carried out without the need to include external oxidizing agents in the reaction. The NIPTU networks can be biowaste-based because the starting materials can be derived from waste sources derived from natural products, such as cashew nutshells or rice husks. Due to their dynamic covalent disulfide crosslinks, the NIPTUs can have excellent reprocessability with complete recovery of crosslink density after multiple reprocessing steps and are useful as self-healing polymers.

One embodiment of a disulfide-crosslinked non-isocyanate polythiourethane network comprises (includes) or consists of a non-isocyanate polythiourethane network having a branched polythiourethane backbone and interchain disulfide crosslinks, wherein the disulfide-crosslinked non-isocyanate polythiourethane network is free of oxidizing agents that promote disulfide crosslink formation and the branched polythiourethane backbone is free of or substantially free of unreacted pendant thiol groups.

One embodiment of a method of forming a disulfide-crosslinked non-isocyanate polythiourethane network includes the steps of: reacting dithiocarbonate molecules having two or more cyclic 5-membered dithiocarbonate rings with polyamine molecules having three or more amine groups to form a crosslinked non-isocyanate polythiourethane network having a branched polythiourethane backbone and interchain disulfide crosslinks, wherein the reaction is carried out in the absence of oxidizing agents that promote disulfide crosslink formation, and further wherein the branched polythiourethane backbone is free of or substantially free of unreacted pendant thiol groups.

One embodiment of a method of reprocessing disulfide-crosslinked non-isocyanate polythiourethane networks includes the steps of: heating one or more pieces of a disulfide-crosslinked non-isocyanate polythiourethane network comprising (or consisting of) a branched polythiourethane backbone and interchain disulfide crosslinks from a first temperature to a second temperature, wherein reversible disulfide linkage dissociation occurs to a greater extent at the second temperature than at the first temperature; reshaping the one or more pieces of the disulfide-crosslinked non-isocyanate polythiourethane network at the second temperature to form a reshaped disulfide-crosslinked non-isocyanate polythiourethane network; and cooling the reshaped disulfide-crosslinked non-isocyanate polythiourethane network to form a reprocessed disulfide-crosslinked non-isocyanate polythiourethane network.

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings, wherein like numerals denote like elements.

FIG. 1. Reaction scheme of synthesizing biobased NIPTU networks (NIPTU(Cyclo) and NIPTU(NC-514)) with inter-chain disulfide linkages, including CS₂ fixation of epoxies (1,4-cyclohexanedimethanol diglycidyl ether (Cyclo) and Cardolite® NC-514 (NC-514)) followed by cyclic thiocarbonate aminolysis with poly (propylene glycol) (PPG)-based amine T-403.

FIG. 2. Reaction scheme of synthesizing analogous PHU networks (PHU(Cyclo) and PHU(NC-514)) through CO₂ fixation of the epoxies and the following cyclic carbonate aminolysis with T-403.

FIGS. 3A-3B. Comparisons of the temperature dependences of storage modulus (E′) and tan δ between (FIG. 3A) NIPTU(NC-514) and PHU(NC-514) and (FIG. 3B) NIPTU(Cyclo) and PHU(Cyclo).

FIG. 4. Stress-elongation curves obtained from room-temperature tensile tests of NIPTU(Cyclo), PHU(Cyclo), NIPTU(NC-514), and PHU(NC-514).

FIGS. 5A-5B. Temperature dependence of storage modulus (E′) and tan δ across three molding cycles of (FIG. 5A) NIPTU(NC-514) and (FIG. 5B) NIPTU(Cyclo).

FIGS. 6A-6D. Creep and recovery curves of (FIG. 6A) NIPTU(NC-514) from 60 to 120° C., and of (FIG. 6C) NIPTU(Cyclo) from 60 to 120° C. Arrhenius plots and activation energy of (FIG. 6B) NIPTU(NC-514) and (FIG. 6D) NIPTU(Cyclo).

FIGS. 7A-7C. Chemical transformations of biobased starting material for NIPTU synthesis: (FIG. 7A) biobased propylene glycol derived from glycerol. (FIG. 7B) 1,4-cyclohexanedimethanol diglycidyl ether (Cyclo) that can be derived from rice husk. (FIG. 7C) Cardolite® NC-514 (NC-514) that are derived from cashew nutshell liquid. The epoxies were used as purchased.

FIG. 8. DSC heat flow curves of as-synthesized NIPTUs and PHUs with dashed lines indicating T_{g} values determined by half ΔCₚ method. (See Table 1for T_{g} values.)

FIGS. 9A-9C. DSC heat flow curves of (FIG. 9A) NIPTU networks for three successive heating cycles from −30° C. to 100° C. and (FIG. 9B) PHUs for three successive heating cycles from −30° C. to 190° C. shown from −20° C. to 60° C. (FIG. 9C) Cycle 1 curves of as-synthesized PHU analogs shown from 60 to 180° C.

FIG. 10. Temperature dependence of storage modulus (E′) and tan δ determined by DMA of NIPTU(Cyclo) synthesized with 1.5 mol % (1 wt %) and 3.6 mol % (2.4 wt %) DBU as catalyst.

FIGS. 11A-11B. Temperature dependence of storage modulus (E′) and tan δ determined by DMA of (FIG. 11A) PHU(NC-514) and (FIG. 11B) PHU(Cyclo) using DBU as catalyst.

FIGS. 12A-12C. (FIG. 12A) Gel content for all NIPTU network and PHU analog samples. (FIG. 12B) and (FIG. 12C) THF swelling ratio of all NIPTU network and PHU analog samples. An excess amount of tri-n-butylphosphine was added into the THF at 48 h.

FIGS. 13A-13D. Loading and unloading tensile hysteresis cycles of (FIG. 13A) NIPTU(NC-514), (FIG. 13B) NIPTU(Cyclo), (FIG. 13C) PHU(NC-514), and (FIG. 13D) PHU(Cyclo).

FIGS. 14A-14B. Tensile properties of (FIG. 14A) dry NIPTU networks and PHU analogs and (FIG. 14B) NIPTU networks and PHU analogs after 72 h water immersion.

FIGS. 15A-15B. Storage modulus (E′) determined by DMA as a function of temperature of samples after immersion in water for various timeframes including comparisons with their dry samples: (FIG. 15A) NIPTU(Cyclo) and (FIG. 15B) PHU(Cyclo).

FIGS. 16A-16D. FTIR spectra of (FIG. 16A) NIPTU(NC-514), (FIG. 16B) NIPTU(Cyclo), (FIG. 16C) PHU(NC-514), and (FIG. 16D) PHU(Cyclo) after 72 h water immersion.

FIGS. 17A-17B. Representative stress-strain curves of (FIG. 17A) NIPTU(NC-514) and (FIG. 17B) NIPTU(Cyclo) across three molding cycles.

FIG. 18. Comparisons of tensile stress-strain curve of original NIPTU(Cyclo) and NIPTU(Cyclo) that was cut in half and healed at 120° C. for 6 h.

FIGS. 19A-19B. Creep and recovery curves of (FIG. 19A) NIPTU(NC-514) under 140° C., and (FIG. 19B) NIPTU(Cyclo) under 140° C.

### DETAILED DESCRIPTION

Disulfide-crosslinked NIPTU networks, methods of making the disulfide crosslinked NIPTU networks, and methods of reprocessing the disulfide crosslinked NIPTU networks are provided.

The polymer backbone chains of the NIPTU networks are branched polythiourethan chains that include two or more thionourethane groups, where a thionourethane refers to a group having the structure:

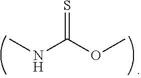

The crosslinked NIPTU networks are rendered reprocessable (recyclable) and self-healing by the presence of covalent disulfide linkages that form crosslink between branched non-isocyanate polythiourethane chains. At elevated temperatures, the disulfide crosslinks undergo dynamic covalent bond breaking a reformation (exchange) which renders the crosslinked NIPTU networks reprocessable. The reprocessability of the NIPTU networks enables them to recover their crosslink densities, mechanical properties, and thermal stabilities after one or more high temperature reprocessing cycles.

Some embodiments of the disulfide crosslinked NIPTUs are formed from renewable, biobased starting materials, making them a good choice as sustainable substitutes for conventional polyurethane (PU) networks and conventional polythiourethane (PTU) networks.

Dithiocarbonate reactants used in the synthesis of the crosslinked NIPTU networks can be synthesized by reacting epoxy molecules having two or more epoxy groups with carbon disulfide (CS₂), via CS₂ fixation of the epoxies, to form dithiocarbonate molecules having two or more cyclic 5-membered dithiocarbonate groups. The use of CS₂ in the synthesis is beneficial because industrial waste gas CS₂ can be sourced from the processing of sour natural gas and combustion of fossil fuels. Furthermore, CS₂ is far less toxic than the precursor of isocyanate, phosgene. The synthesis of the dithiocarbonate molecules may be carried out in solution in the presence of a catalyst that is catalytically active for the conversion of the epoxies to the cyclic dithiocarbonate groups. Suitable catalysts include lithium bromide.

The dithiocarbonate molecules are then reacted with polyamine molecules having three or more amine groups to form a disulfide crosslinked NIPTU network via aminolysis and the coupling of thiol groups into disulfide linkages. The synthesis of the NIPTU networks may be carried out in solution in the presence of a catalyst that is catalytically active for the aminolysis reaction. Suitable catalysts include 1,8-diazabicyclo (5.4.0) undec-7-ene (DBU). However, the disulfide crosslinks can be formed solely via auto-oxidation and do not require an oxidizing agent that promotes the formation of the disulfide crosslinks and, as such, oxidizing agents can be omitted from the reaction and oxidizing agents (including their reduced forms) can be absent from the NIPTU networks. Oxidizing agents that promote disulfide crosslink formation that may be excluded from the synthesis include metal oxides, such as MnO₂, PbO₂, KMnO₄, ZnCrO₄, Na₂Cr₂O₇, CaO₂, BaO₂, Na₂O₂, and Na₂B₂O₄(OH)₄. and organic oxidizing agents, such as .p-benzoquinone dioxime, cumene, and hydroperoxide. The crosslinking the branched polythiourethane backbone chains in the networks can also be carried out with the use of additional crosslinking agents, such as polyacrylates.

Notably, even in the absence of oxidizing agents, the formation of disulfide crosslinks can go to completion or substantially to completion, to form disulfide crosslinked NIPTU networks in which the branched polythiourethane backbone is substantially free of unreacted pendant thiol groups. The absence of unreacted pendant thiol groups can be confirmed via FTIR, whereby the FTIR spectrum of a polythiourethane backbone that is free of unreacted pendant thiol groups will be free of peaks corresponding the S—H groups, as described in the Example. While it is desirable for the NIPTU networks to be free of unreacted thiol groups, a small number of unreacted thiol groups may be present after network formation. If the number of unreacted thiol groups is 5% or less of the number of unreacted thiol groups plus the number of thiol groups that have reacted to form disulfide crosslinks, the NIPTU network can be considered “substantially free” of unreacted thiol groups.

The synthesis of the NIPTU networks can be carried out at an elevated temperature, and the initial network polymerization may be followed by curing at an elevated temperature to promote the formation of the disulfide crosslinks. As used herein, the term “elevated temperature” refers to temperatures above room temperature (e.g., above about 23° C.). Suitable temperatures will depend on the selected reactants and catalyst; however, temperatures of 60° C. and greater (e.g., temperatures in the range from 60° C. to 150° C., including temperatures in the range from 60° C. to 100° C.) are typically suitable.

A variety of organic solvents can be used to carry out the reactions, provided the reactants are substantially soluble therein and the solvents have boiling point temperatures above the synthesis temperature.

Diepoxy molecules that can be used to form a dithiocarbanate have the structure:

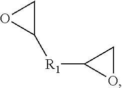

where R₁ represents an ether group. The ether group may be an aliphatic ether group (an ether group in which an aliphatic group is bonded to the ether oxygen), including a cycloaliphatic ether group, or an aromatic ether group (an ether group in which an aromatic group is bonded to the ether oxygen). The epoxy molecules are desirably derived from natural products, including biobased waste sources, to promote sustainability. For example, cashew nutshell liquid is a waste by-product from cashew production that is inexpensive, renewable, and has been utilized as a natural substitute for phenol. Cardanol, which can be separated from cashew nutshell liquid, can be easily transformed into an epoxy molecule for use in the synthesis of the NIPTU networks. Other examples include epoxy molecules derived from p-xylene, a biobased compound that can be derived from raw biowaste material, such as rice husks.

The dithiocarbonate molecules made from the diepoxy molecules described above have the structure:

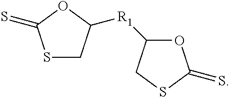

Various polyamines can be used to form the NIPTUs. As used herein, the term “polyamine” refers to a molecule having at least two amine functionalities. Triamines are polyamines having three amine functionalities. Tetraamines are amines having four amine functionalities. Various types of polyamines can be used in the synthesis of the non-isocyanate polyurethanes, including polyether amine. Poly (alkylene glycol) polyamines, including poly (propylene glycol) (PPG) polyamines and poly (ethylene glycol) (PEG) polyamines are examples. Branched poly (alkylene glycol) polyamines are characterized by a branched poly (alkylene glycol) core functionalized with three or more amine groups, which are typically at the ends of the poly (alkylene glycol) chains. By way of illustration only, the structure of a poly (propylene glycol) triamine has the structure:

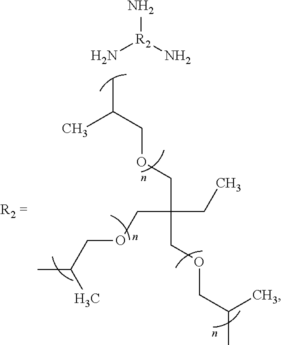

where n represents the number of repeat units in the polymer chain. The value of n can be chosen to provide a non-isocyanate polyurethane with the desired properties for a given application. By way of illustration, polyether triamines having molecular weights in the range from about 400 g/mol to about 5000 g/mol are commercially available under the tradename Jeffamine. The use of polypropylene glycol-based polyamines is beneficial because propylene glycol is classified as a renewable bioproduct by the US Department of Energy, and biobased propylene glycol, which has been commercialized by Corechem, can be derived from glycerin, a major byproduct from the biodiesel industry.

The disulfide-crosslinked NIPTU networks are reprocessable with the ability to self-heal and exhibit high creep resistance at temperatures up to 80-100° C. Thus, the disulfide-crosslinked NIPTU networks are not only renewable but also recyclable, and their crosslinks are robust at many tens of degrees above room temperature.

The reprocessability of the NIPTU networks is reflected by their ability to recover their crosslinking density and mechanical properties after undergoing one or more reprocessing cycles. The dynamic crosslinked polymer networks may be reprocessed by heating them from a temperature at which dynamic dissociation of the disulfide linkages is inactive or substantially inactive, such as room temperature (23° C.), to an elevated temperature at which the dynamic dissociation is activated or significantly enhanced. The heating may be conducted under an applied pressure and/or in a mold. Illustrative elevated temperatures include those of at least 100° C. and at least 120° C., including temperatures in the range from 100° C. to 180° C. and in the range from 120° C. to 160° C. While at the elevated temperature, the NIPTU networks may be reshaped (e.g., via molding, compression, and or extrusion) and then cooled, e.g., to room temperature. During cooling, the disulfide linkages recombine, thereby reforming the crosslinked NIPTU networks. The reprocessing of the disulfide-crosslinked NIPTU networks produces a bulk shape change in one or more objects made from the networks. This change in shape may be the result of two or more pieces of the disulfide-crosslinked NIPTU networks joining together or an object composed of a single piece of disulfide-crosslinked NIPTU network undergoing a change in shape.

For the purposes of this disclosure, a single reprocessing cycle refers to a single round of heating, reshaping, and cooling. Notably, the heating used to reprocess the networks can be quite short (e.g., 6 hours, 2 hours, 1 hour, or less) and still provide the reprocessed NIPTU networks with full recovery of crosslinking density (as compared to the initial NIPTU networks prior to any reprocessing). As a standard test for reprocessability, the crosslinked NIPTU networks can be heated to 140° C., sustained at that temperature for 120 minutes or less, and then allowed to cool to room temperature (23° C.), as described in the Example.

The crosslinking density of the disulfide-crosslinked NIPTU networks is reflected in their high tensile storage moduli (E′). By way of illustration, disulfide-crosslinked NIPTU networks having E′ values of 1.0 MPa or greater, including E′ values in the range from 6 to 12 MPa, at temperatures in the range from 23° C. to 100° C. (for example, at 80° C.), can be formed using the methods described herein.

The reprocessability of the disulfide-crosslinked NIPTU networks is reflected in the recovery of their crosslinking density and E′ after one or more reprocessing cycles. Other mechanical properties that may be recovered after one or more reprocessing cycles include the NIPTU network's Young's modulus, tensile strength, and/or strain at break. Appropriate methods for measuring each of these properties are described in the Example. As illustrated in the Example, any one or more of, or all of, these mechanical properties may be recovered to a level of at least 75%, at least 80%, at least 85%, at least 90%, at least 95%, or even 100% after the NIPTUs undergo reprocessing. For the purposes of quantifying the recovery of the mechanical properties of a disulfide-crosslinked NIPTU network, said properties can be measured after three reprocessing cycles at a temperature of 140° C. under a 7-ton ram force, as described in the Example below. Unless otherwise indicated, the mechanical properties of a reprocessed disulfide-crosslinked NIPTU network refer to said property as measured at 23° C.

### EXAMPLE

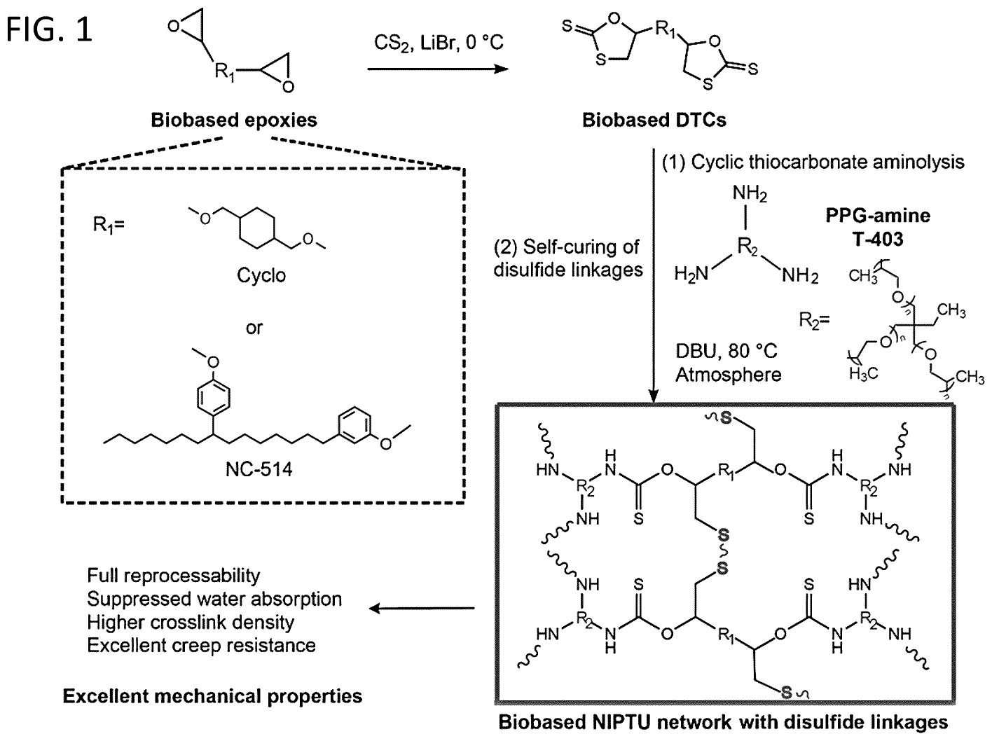

This Example illustrates the synthesis and characterization of reprocessable NIPTU networks made with both thionourethane linkages and disulfide linkages as crosslinks. From a scientific standpoint, structure-property relationships in such NIPTU networks were addressed, and comparisons were drawn to structurally analogous PHU networks which lack disulfide linkages. In addition to the reprocessability of these NIPTU networks, this Example also addresses sustainability issues by being the first to prepare renewable NIPTU networks from biobased waste material. (See FIG. 1.) For example, NC-514-DTC is derived from Cardolite® NC-514 which is derived from cashew nutshell liquid, and Cyclo-DTC is derived from p-xylene which can be derived from rice husks. These biowaste-based NIPTU networks exhibit enhanced crosslink densities and properties compared to their PHU analogs. Moreover, NIPTU networks exhibit much better water resistance than their PHU analogs. Finally, these biowaste-based NIPTU networks exhibit excellent creep resistance at elevated temperatures up to 80-100° C. Based on a series of comparison studies, the usefulness of the NIPTU networks as substitutes for traditional PU networks is demonstrated.

### Experimental Section

Materials. JEFFAMINE® T-403 polyetheramine (trimethylolpropane tris[poly(propylene glycol), amine terminatedJether, referred to as T-403, amine hydrogen equivalent weight=81 g/eq) was kindly provided by Huntsman. Epoxy ERISYS@ GE-22 (1,4-cyclohexanedimethanol diglycidyl ether, referred to as Cyclo, epoxy equivalent weight=145-165 g/eq) was kindly provided by CVC Thermoset Specialties. Biobased epoxy Cardolite® NC-514 (referred to as NC-514, epoxy equivalent weight=350-500 g/eq) was kindly provided by Cardolite Corporation. 1,8-diazabicyclo [5.4.0] undec-7-ene (DBU), carbon disulfide (CS2, anhydrous, ≥99%), 4-dimethylamino pyridine (DMAP, ≥99%), tetrabutylammonium iodide (TBAI, reagent grade, 98%), N,N′-dimethylformamide (DMF), tetrahydrofuran (THF, anhydrous, ≥99.9%), chloroform-d (CDC13, 99.8 atom % D), ethyl acetate (≥99.5%), lithium bromide (LiBr), 1,2,4,5-tetrachlorobenzene (98%), and tri-n-butylphosphine (97%) were purchased from Sigma-Aldrich. Materials were used as received.

Determination of epoxy equivalent weight (EEW) of epoxies. The epoxy equivalent weight (EEW) of the epoxies Cyclo and NC-514 was determined using ¹H nuclear magnetic resonance (1H NMR) spectroscopy with 1,2,4,5-tetrachlorobenzene as internal reference. Cyclo was used as an example. Cyclo (105.6 mg) and 1,2,4,5-tetrachlorobenzene (16.9 mg) were dissolved in chloroform-d (CDCl₃) and subjected to ¹H NMR characterization. The characteristic peaks of epoxy (n, m, m′) and —CH of 1,2,4,5-tetrachlorobenzene (˜7.56 ppm) were integrated. The EEW value of Cyclo was calculated according to Eq. (1) as follows:

$$EEW ( \frac{g}{mol} ) = \frac{\frac{{I}_{ref}}{2} * {m}_{ep}}{{I}_{ep} * {n}_{ref}} \qquad ( 1 )$$

where I_{ref} is the peak intensity of the two protons on 1,2,4,5-tetrachlorobenzene, mₑₚ is the weight of Cyclo added in the sample, Iₑₚ is the average intensity of the epoxy characteristic peak n, m, and m′, and n_{ref} is the molar amount of 1,2,4,5-tetrachlorobenzene added in the sample. The calculated EEW of Cyclo was 154 g/mol. ¹H NMR: (500 MHz, CDCl₃) δ 3.70 (dd, J=11.6, 3.1 Hz, 2H), 3.43-3.24 (m, 6H), 3.21-3.07 (m, 2H), 2.80-2.75 (m, 2H), 2.67-2.56 (m, 2H), 1.92-1.77 (m, 4H), 1.63-1.49 (m, 1H), 1.01-0.91 (m, 4H). ¹³C NMR: (126 MHz, CDCl₃) δ 77.28, 71.61, 50.89, 44.20, 38.19, 29.27.

The EEW of NC-514 was determined in a similar manner to Cyclo based on Eq. (1), with a calculated EEW of 470 g/mol. ¹H NMR (500 MHZ, CDCl₃) 8 7.21-7.10 (m, 2H), 7.00-6.60 (m, 6H), 4.20 (dd, J=10.9, 3.4 Hz, 2H), 4.01-3.88 (m, 2H), 3.62-3.29 (m, 2H), 2.98-2.82 (m, 2H), 2.76 (dd, J=4.7, 2.2 Hz, 2H), 2.56 (dd, J=10.8, 4.9 Hz, 4H), 1.60-1.52 (m, 4H), 1.45-1.09 (m, 21H), 1.02-0.73 (m, 3H). ¹³C NMR (126 MHz, CDCl₃) δ 158.50, 144.74, 129.44, 129.22, 121.45, 115.92, 114.96, 111.50, 68.64, 50.21, 44.81, 36.01, 33.97, 32.63, 31.37, 30.37-28.53 (m), 22.68.

Synthesis and characterization of cyclic dithiocarbonate (DTC). Cyclo-DTC and NC-514-DTC were prepared as monomers to synthesize NIPTU networks. DTCs were prepared by CS₂ fixation of corresponding epoxy precursors (according to the corresponding EEW values).

Here, the synthesis of Cyclo-DTC was used as an example. In a specific synthesis, 10.0 grams of Cyclo (EEW=154 g/mol) and 1:1 molar ratio of lithium bromide (5.6 g) to epoxy group were weighed. Then lithium bromide was slowly dissolved in 40 mL THF in a 100 mL round bottom flask. After adding an excess amount of carbon disulfide (10.9 g, 1:2.2 molar ratio to epoxy groups) to the round bottom flask, the flask was maintained in a 0° C. ice bath with constant stirring during the reaction. Then the weighed epoxy Cyclo was loaded into a syringe set up on a KD Scientific syringe pump with a pumping rate of 14 mL/h for adding epoxy into the flask. After the dropwise addition of epoxy, the flask was left in the ice bath overnight before washing the product with ethyl acetate and brine solution. A yellow, highly viscous liquid was obtained after drying the product using a rotary evaporator at 60° C. and vacuum at 80° C. for 2 days. ¹H NMR (500 MHZ, CDCl₃): δ 5.45-5.06 (m, 2H), 4.04-3.55 (m, 8H), 3.34 (d, J=6.4 Hz, 2H), 1.85-1.71 (m, 4H), 1.63-1.48 (m, 2H), 1.07-0.78 (m, 4H). ¹³C NMR (126 MHz, CDCl₃): δ 211.94, 89.25, 77.68, 69.56, 38.06, 36.12, 29.11.

NC-514-DTC was synthesized via the same procedure using the corresponding epoxy NC-514 (EEW=470 g/mol). A brown, highly viscous liquid was obtained. ¹H NMR (500 MHz, CDCl₃): δ 7.23-7.08 (m, 2H), 6.97-6.63 (m, 6H), 5.59-5.30 (m, 2H), 4.52-4.24 (m, 4H), 3.98-3.57 (m, 4H), 2.65-2.46 (m, 4H), 1.73-1.55 (m, 4H), 1.39-1.15 (m, 21H), 0.97-0.74 (m, 3H). ¹³C NMR (126 MHz, CDCl₃): δ 211.32, 157.80, 145.03, 129.43, 122.14, 115.93, 114.85, 111.52, 87.84, 66.27, 36.38, 36.00, 33.98, 32.64, 31.96, 31.38, 29.72, 29.66-28.45 (m), 25.42, 23.65-21.97 (m), 14.51-13.81 (m).

The DTC equivalent weight (DEW) of the DTCs were also determined using 1H NMR spectroscopy with 1,2,4,5-tetrachlorobenzene as internal reference. Taking Cyclo-DTC for example, Cyclo-DTC (42.2 mg) and 1,2,4,5-tetrachlorobenzene (34.0 mg) were dissolved in CDCl₃. One of the three characteristic peaks of DTC ring (n, ˜5.25 ppm) and —CH of 1,2,4,5-tetrachlorobenzene (˜7.56 ppm) were integrated. The DEW of Cyclo-DTC was calculated according to Eq. (2) as follows:

$$DEW ( \frac{g}{mol} ) = \frac{\frac{{I}_{ref}}{2} * {m}_{DTC}}{{I}_{DTC} * {n}_{ref}} \qquad ( 2 )$$

where I_{ref} is the peak intensity associated with the two protons on 1,2,4,5-tetrachlorobenzene (˜7.56 ppm), m_{DTC} is the weight of Cyclo-DTC added in the sample, I_{DTC} is the intensity of the peak n of Cyclo-DTC, n_{ref} is the molar amount of 1,2,4,5-tetrachlorobenzene added in the sample. The calculated DEW of Cyclo-DTC was 233 g/mol, which is very close to EEW of Cyclo plus the molar mass of CS₂ (154+76 g/mol). This indicates that complete conversion of the epoxy groups in Cyclo into DTC groups was achieved.

The DEW of NC-514-DTC was determined in a manner similar to that of Cyclo-DTC based on Eq. (2), with a calculated DEW of 548 g/mol. This value is very close to the EEW of NC-514 plus the molar mass of CS₂ (470+76 g/mol), indicating nearly complete conversion of epoxy groups into DTC groups.

The synthesis of CC and the determination of CC equivalent weight (CEW) are described below.

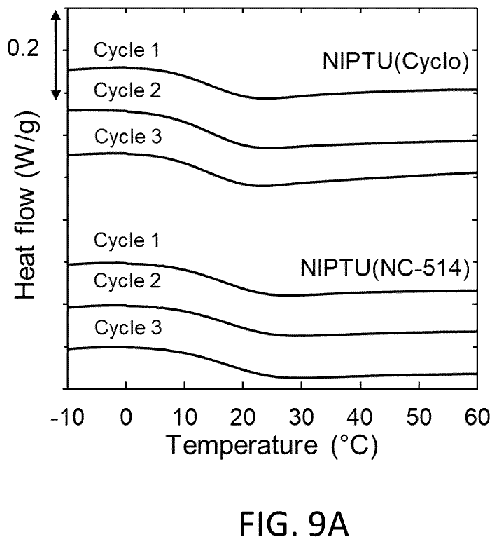

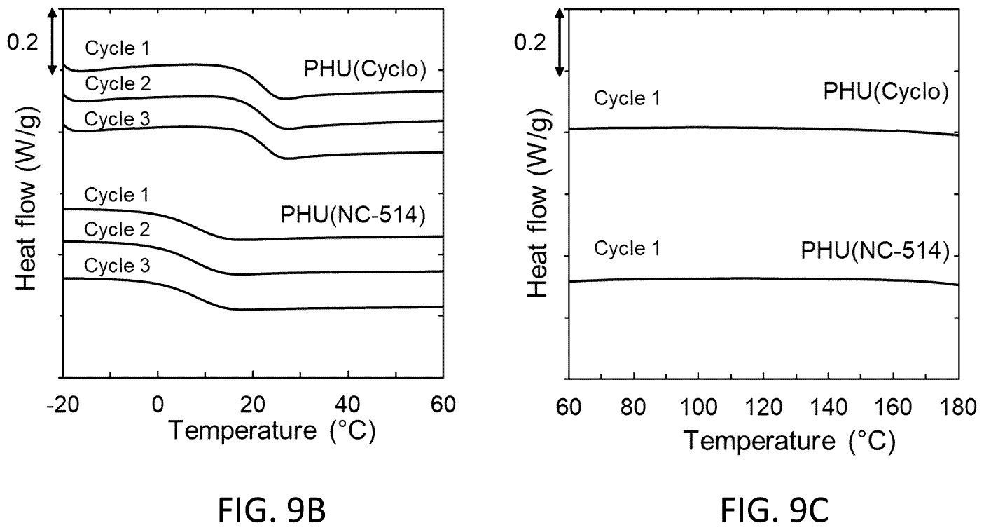

Synthesis of NIPTU networks by cyclic thiocarbonate aminolysis. The NIPTU networks were synthesized from DTC (according to the corresponding DEW values) and trifunctional amine, T-403. The NIPTU network synthesized from Cyclo-DTC was named NIPTU(Cyclo), and the NIPTU network synthesized from NC-514-DTC was named NIPTU(NC-514). (See FIG. 1 for structures of NIPTU(Cyclo) and NIPTU(NC-514).) In a specific synthesis, Cyclo-DTC (2.0 g, DEW=233 g/mol) was weighed in a Max20 cup (Flacktek). A catalyst solution of 1.5 mol % DBU (1 wt %, 20 mg) was prepared using 1 mL THF as solvent. After adding the catalyst solution to the Max20 cup, the catalyst solution and Cyclo-DTC were mixed for 5 min using a speed mixer (Flacktek DAC 150.1 FVZ-K) at 3000 rpm. T-403 (1.4 g, amine hydrogen equivalent weight=81 g/eq) solution was prepared using 1 mL THF as solvent. The T-403 solution was added into the Max20 cup containing the dissolved Cyclo-DTC and catalysts and then mixed for 5 min at 3000 rpm in the speed mixer. The resulting mixture was maintained on a hot plate without stirring at 80° C. Gelation occurred within 1 h. Then the resulting elastomeric solid was cut into small pieces and heated at 80° C. overnight in air atmosphere to perform curing and to eliminate the solvent before characterization. NIPTU(NC-514) was synthesized via the same procedure using the corresponding DTC (NC-514-DTC, DEW=548 g/mol) using 3.6 mol % DBU (1 wt %) as catalyst. DSC experiments were performed on the as-synthesized NIPTU networks to check for residual solvent, and no significant solvent residues were evident. (See FIGS. 9A-9C.) The product from NIPTU syntheses were examined by FTIR spectroscopy.

Synthesis of analogous PHU networks by cyclic carbonate aminolysis. Analogous PHU networks were synthesized from the corresponding CCs following a procedure similar to past reports. (Kihara, N. et al., J. Polym. Sci., Part A: Polym. Chem. 1993, 37, 2765-2773; Tomita, H. et al., J. Polym. Sci., Part A: Polym. Chem. 2001, 39, 3678-3685; Blattmann, H. et al., Macromol. Rapid Commun. 2014, 35, 1238-1254; Leitsch, E. ct al., ACS Macro Lett. 2016, 5, 424-429; Chen, X. et al., Polym. Chem. 2017, 8, 6349-6355; Fortman, D. et al., J. Am. Chem. Soc. 2015, 137, 14019-14022; Fortman, D. J. et al., ACS Macro Lett. 2018, 7, 1226-1231; Beniah, G. et al., Eur. Polym. J. 2016, 84, 770-783; Beniah, G. et al., Macromolecules 2017, 50, 4425-4434.)

¹H nuclear magnetic resonance (NMR) spectroscopy. ¹H NMR spectroscopy was done using a Bruker Avance III 500 MHz NMR spectrometer at room temperature. Chemical shifts were quoted in ppm relative to tetramethylsilane (TMS), using the residual solvent chloroform peak as the reference standard.

¹³C NMR spectroscopy. Proton decoupled ¹³C NMR spectra were obtained at room temperature using a Bruker Avance 500 MHz NMR spectrometer with direct cryoprobe (126 MHZ). Chemical shifts were quoted in ppm relative to tetramethylsilane (TMS), using the residual solvent chloroform peak as the reference standard.

Fourier transform infrared (FTIR) spectroscopy. Attenuated total reflectance-Fourier transform infrared (ATR-FTIR) spectroscopy was performed at room temperature employing a Bruker Tensor 37 MID IR FTIR spectrophotometer with a diamond/ZnSe attachment. Sixteen scans were collected over the 4000 to 600 cm⁻¹ range with a 4 cm⁻¹ resolution.

Swelling tests. Swelling tests were conducted at room temperature using THE as swelling solvent. All NIPTU and PHU samples were swelled for 48 h to equilibrium. Swollen samples were weighed immediately after removing excess solvent at the surface of the samples with tissues to obtain swelling ratio values by (ms-ma)/ma, where ms and ma are the masses of swollen and dry samples, respectively. Samples swelled for 48 h were dried at 80° C. under vacuum for 2 days before weighing to obtain gel content values by mg/ma, where mg is the mass of dried sample gel fraction.

To demonstrate the existence of disulfide crosslinks, an excess amount of tri-n-butylphosphine (1:2 molar ratio to DTC groups) was added into THF when NIPTU networks were swelled to equilibrium at 48 h. The swelling ratio was measured 24 h after the addition of tri-n-butylphosphinc.

Differential scanning calorimetry (DSC). The glass transition temperatures (T_{g}s) of the as-synthesized NIPTU networks and PHU analogs were characterized using a Mettler Toledo DSC822e. Samples were heated at a rate of 10° C./min and cooled at a rate of −40° C./min. The testing cell was held isothermally for 5 min for the sample to reach thermal equilibrium before each heating or cooling ramp. All T_{g} values were obtained from a second heating ramp at 10° C./min and determined using the half ΔCₚ method. DSC was also used to check for potential solvent residues in the as-synthesized NIPTU and PHU samples; no significant solvent residues were evident. (See FIGS. 9A-9C.)

Processing and reprocessing. Thermal (re) processing was carried out by cutting the sample into small pieces and placing them into a hot compression molder (PHI press, model 0230C-X1). For each molding step, the NIPTU(NC-514) and PHU(NC-514) samples were molded at 140° C. using a 7-ton ram force for 2 h and the NIPTU(Cyclo) and PHU(Cyclo) samples were molded at 140° C. using a 7-ton ram force for 1 h. After molding or remolding, samples were cooled to room temperature in a cold compression mold using a 3-ton ram force.

Dynamic mechanical analysis. Tensile-mode dynamic mechanical analysis (DMA) was performed with a TA Instruments Rheometric Stress Analyzer-GII. Rectangular specimens ˜2.5 mm in width and ˜0.8 mm in thickness were mounted on the fixture and subjected to temperature sweeps from −20° C. to 100° C. at a ramp rate of 3° C./min. Measurements were conducted in tension mode at 1 Hz frequency. The storage modulus (E′), loss modulus (E″), and tan δ (E′/E′) values were recorded.

Tensile testing. Tensile tests were performed at room temperature using an MTS Criterion Electromechanical Test System with an extension rate of 130 mm/min and a data acquisition frequency of 350 Hz. Sample sheets from the hot-press were cut into dog-bone-shaped specimens with 4.7 mm×0.7 mm×22 mm dimensions using a Dewes-Gumbs dic. From the obtained stress-strain curves, the tensile strength was reported as the maximum value of stress, and Young's modulus (E) was obtained from E=Δσ/Δε, where Δσ and Δε were the changes of stress and strain during the initial linear portion of the stress-strain curve, in the limit of zero strain.

Water absorption experiments. Water absorption experiments were performed by immersing NIPTU network and PHU analog sample strips into 20 ml vials containing 15 mL water. In a typical measurement, NIPTU(Cyclo) sample strips were divided into three groups and were put into separate vials with water after being weighed. The vials were marked as 24 h, 48 h, and 72 h. As immersion of the corresponding timeframes, the sample strips were removed from water, and the water on the strip surface was carefully soaked away before weighing the sample. Each sample strip was then immediately subjected to FTIR, DMA, or tensile characterization. The measurements for PHU(Cyclo), NIPTU(NC-514), and PHU(NC-514) were conducted similarly.

Creep and recovery experiments. Shear creep experiments were performed on ˜2 mm-thick disk samples using an Anton-Paar MCR 302 shear rheometer with 25 mm parallel-plate fixtures. The samples were equilibrated at the testing temperature (60/80/100/120/140° C.) before the experiment started. For each measurement, a shear stress of 3.0 kPa was applied for 40000 s followed by 10000 s recovery with no stress applied.

To exclude strain contributed by the initial delayed elastic deformation, creep strain values (Δε) were calculated as the difference in the strain at 1=40000 s and 1=3000 s. The network viscosity (η) was calculated using η=σ/\dot{y}, where σ is the creep shear stress of 3000 Pa, and \dot{y} is the shear strain rate calculated from the fitted slope of the linear portion of the creep curves between 1=26000 s to t=40000 s. The instantaneous strain recovery was calculated by dividing the strain recovered over 2 s after the stress was removed by the maximum strain. The residual strain was measured as the final strain after 10000 s recovery. The total strain recovery was calculated by dividing the strain recovered after stress removal by the maximum strain.

Self-healing tests. Self-healing tests were performed on NIPTU(Cyclo) for demonstration purposes. NIPTU(Cyclo) sample strips (˜0.8 mm×4.5 mm) were cut in half, and the halves were immediately put in close contact at the fracture. The samples were healed at 120° C. for 6 h before testing. The healed samples were naturally cooled to room temperature and then hung with a ˜120 g weight. Tensile tests were also performed on the healed samples using procedures described above.

Tensile hysteresis tests. Cyclic tensile hysteresis tests were performed using TA Instruments Rheometric Stress Analyzer-GII at 50° C. with a 0.1 mm/s strain rate and 50% of total strain. A 5 min interval was applied between every load and unload cycle. The energy dissipation (KJ/m⁻³) was calculated from the integration of the area between load and unload curves.

### Results and Discussion

Biobased NIPTU Networks with Thionourethane and Disulfide Crosslinks and Their Analogous PHU Networks: Syntheses and Spectroscopic Characterization. The cashew-nutshell-liquid-derived epoxy NC-514 has been demonstrated to be a mixture of oligomers and contains a small fraction of open epoxy rings. (Jaillet, F. et al., Eur. J. Lipid Sci. Technol. 2014, 116, 63-73.) No report has been published using this biowaste-derived epoxy NC-514 to synthesize DTC and prepare NIPTU. Here, NC-514-DTC was synthesized via CS₂ fixation of NC-514 in the presence of LiBr as catalyst at 0° C. (See FIG. 1.) Because the reaction is much faster than CO₂ fixation of epoxy, the reaction rate was constrained by drop-wise addition of NC-514 solution into the reaction mixture. The products were examined by ¹³C NMR spectroscopy. The appearance of the DTC characteristic C=S signal (peak x) at 211 ppm and the methine (peak n) and methylene signals (peak m) at 88 ppm and 36 ppm, respectively, indicate the successful synthesis of NC-514-DTC. In addition, the absence of signals associated with CS₂ (˜193 ppm) and the epoxy group methine (˜51 ppm) indicates that no significant level of reactant was retained in the collected DTC product. Within experimental uncertainty, complete conversion of epoxy groups into DTC groups was also demonstrated by equivalent weight calculations.

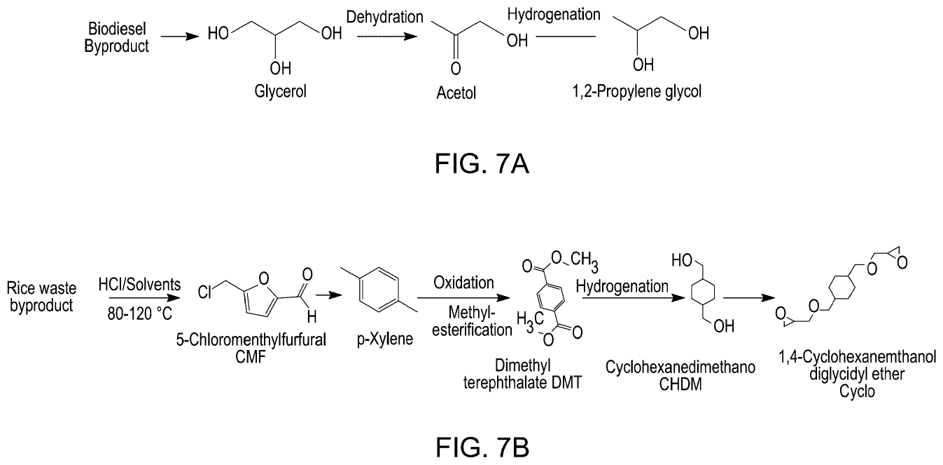

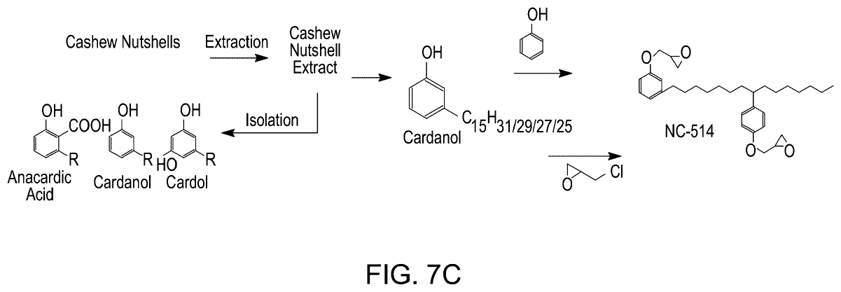

Cyclo-DTC was also prepared via CS₂ fixation of the epoxy Cyclo that can be derived from p-xylene. It is widely reported that p-xylene can be derived from bio-chloromethylfurfural, which can be extracted from rice husk. (See FIGS. 7A-7C.) (Mascal, M. ChemSusChem 2015, 8, 3391-3395; Chen, B. et al., Appl. Catal. B: Environmental 2022, 318, 121842.) Cyclo-DTC was synthesized using the same conditions as in the synthesis of NC-514-DTC. The products were examined by ¹³C NMR spectroscopy and the appearance of the C=S signal at 212 ppm was observed, indicating the successful synthesis of Cyclo-DTC.

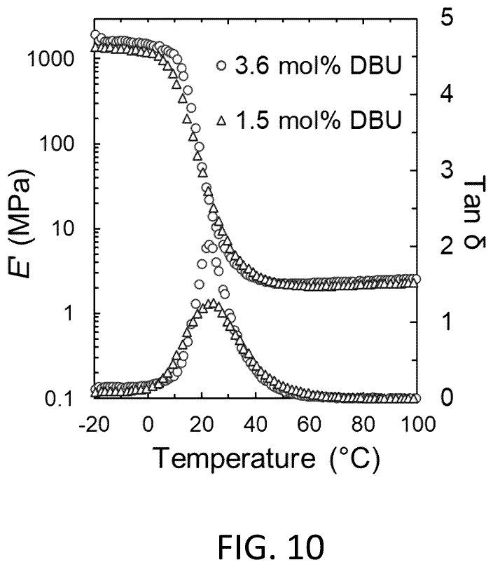

Renewable NIPTU networks were prepared by reacting the DTCs with trifunctional poly (propylene glycol) (PPG)-based amine T-403 to generate branching network structures. The NIPTU network synthesized from NC-514-DTC was named NIPTU(NC-514); the NIPTU synthesized from Cyclo-DTC was named NIPTU(Cyclo). (See FIG. 1 for structures of NIPTU networks.) Because of the high room-temperature viscosities of NC-514-DTC and Cyclo-DTC, which makes homogeneous mixing a challenge, solution polymerizations were done for polymer synthesis. A minimum amount (˜2 mL) of THF was added as solvent, and a speed mixer was employed to ensure sufficient mixing of DTC, amine, and DBU as catalyst. (A DBU concentration as low as 1.5 mol % relative to DTC groups can produce NIPTU networks with relatively high conversion. A higher concentration of 3.6 mol % DBU leads to NIPTU networks with rubbery plateau moduli similar to those of networks made with 1.5 mol % DBU. See FIG. 10.) Thereafter, cyclic thiocarbonate aminolysis was conducted at 80° C., with the gelation observed after ˜1 h. Following gelation, the NIPTU networks were heated at 80° C. overnight in air atmosphere to eliminate solvent.

The successful syntheses of NIPTU(NC-514) and NIPTU(Cyclo) was confirmed by FTIR spectroscopy. A band at 1110 cm⁻¹ was assignable to the C═S bond in the N—C(═S)—O moiety from the thionourethane linkages, consistent with the reaction between DTC and amine groups. (Suzuki, A, 2004.) A band at 3325 cm⁻¹ was assignable to —NH— moieties, also consistent with successful NIPTU synthesis. Complete conversion of DTC within experimental uncertainty was indicated by the disappearance of the thiocarbonate moiety in DTC at 1200 cm⁻¹. (A thiocarbonate peak at 1200 cm⁻¹ was present in the FTIR spectra of both DTCs) Importantly, for both NIPTU networks, the absence of stretching bands was noted at ˜2550 cm⁻¹ in the FTIR spectra associated with —SH groups that should be generated during polymerization. Their absence was consistent with coupling reactions between thiol groups into disulfide linkages. The absence of FTIR signal associated with —SH groups in the NIPTU networks was consistent with auto-oxidation leading to effective coupling of thiol groups into disulfide linkages in the absence of added catalyst or oxidant to promote coupling.

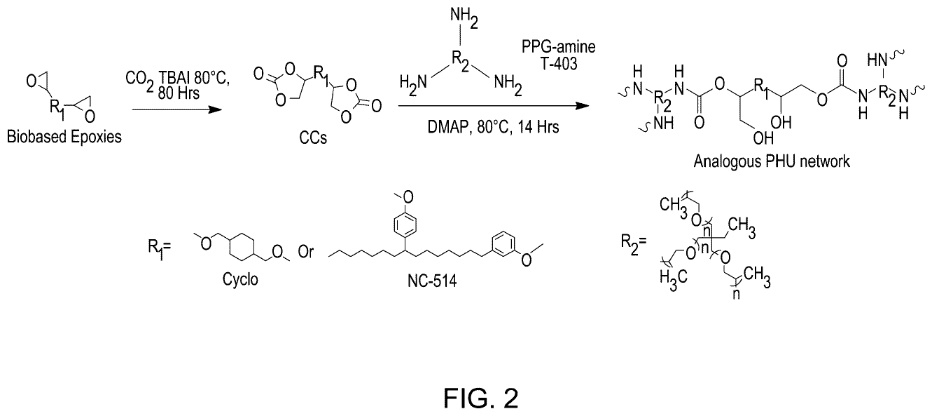

To draw meaningful comparisons of NIPTU networks with thionourethane and disulfide crosslinks to PHU analogs with hydroxyurethane crosslinks and hydroxyl groups capable of undergoing hydrogen bonding, PHU analogs were synthesized that were structural analogs to the NIPTU networks. (See FIG. 2.) Because the NIPTU networks and their PHU analogs were made from identical epoxy and amine precursors, the structural differences between the NIPTU networks and PHU analogs were limited to the presence of thionourethane vs. hydroxyurethane crosslinks and disulfide crosslinks vs. hydroxyl groups. NC-514-CC and Cyclo-CC were prepared by CO₂ fixation of corresponding epoxies at 80° C. in the presence of TBAI as catalyst. The reactions were conducted for at least 80 h to ensure the full conversion of epoxy into CCs. It was noted that the reaction rate associated with CC production was significantly lower than the rate of the reaction conducted at 0° C. for the synthesis of DTCs. The syntheses of CCs were confirmed by ¹H NMR. The full conversion of epoxies into CCs was confirmed by the disappearance of peaks associated with epoxy moicties and the appearance of peaks associated with CC moieties. Similarly, within experimental uncertainty, complete conversion of epoxy groups into CC groups was demonstrated by equivalent weight calculations.

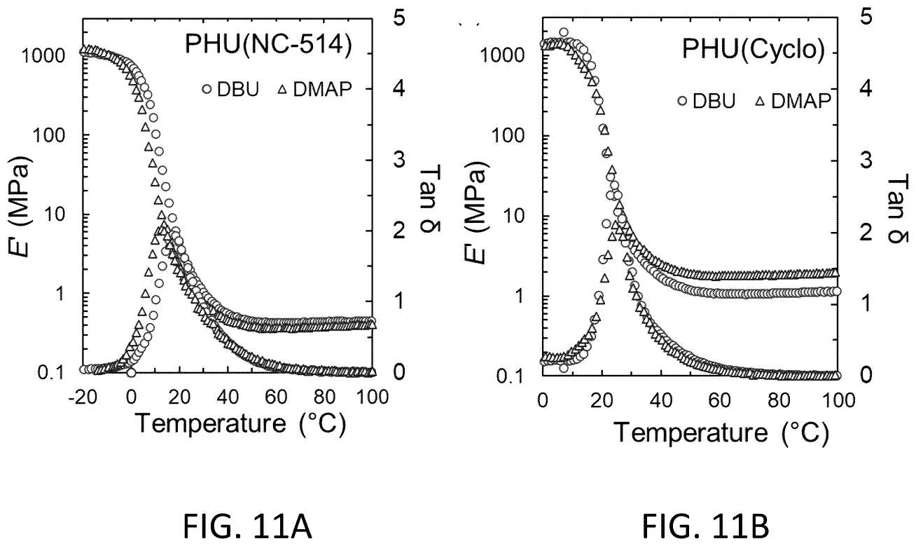

The CCs were then reacted with T-403 by solution polymerization with ˜2 mL DMF as solvent and 5 mol % DMAP as catalyst at 80° C. to prepare analogous PHU networks. The higher boiling point solvent DMF was used because cyclic carbonate aminolysis has lower reactivity and requires longer reaction time at 80° C. DMAP catalyst was also used to promote (re) processability of PHU analogs. (When the catalyst DBU was substituted for DMAP, the resulting PHU(Cyclo) network exhibited a significantly lower rubbery plateau modulus and hence crosslink density. See FIGS. 11A-11B.) The analogous PHU networks synthesized from NC-514-CC and Cyclo-CC were named PHU(NC-514) and NIPTU(Cyclo), respectively. (See FIG. 2 for PHU analogs structures.) After 14 h of reaction, the gelled PHU analogs were held at 80° C. for 3 days under vacuum for post-curing and to eliminate solvent. Nearly complete conversion was achieved in PHU(Cyclo) after ˜90 h of reaction and curing as indicated by the near disappearance of FTIR signal associated with the cyclic carbonate moicty. In contrast, even after long reaction time, small levels of NC-514-CC residues remained in PHU(NC-514), as indicated by a small FTIR stretching peak at 1780 cm⁻¹. The apparently lower reactivity of NC-514-CC relative to Cyclo-CC can be explained in part by the lower molar concentration of functional groups in a system containing the bulkier NC-514-CC relative to the more compact Cyclo-CC. It is widely accepted that one of the main challenges with PHUs is the slow and usually incomplete conversion of CCs due to the low reactivity of PHU. This challenge with PHUs was also evident in this Example, where ˜90 h of reaction and pre-curing time can still lead to incomplete conversion of CC.

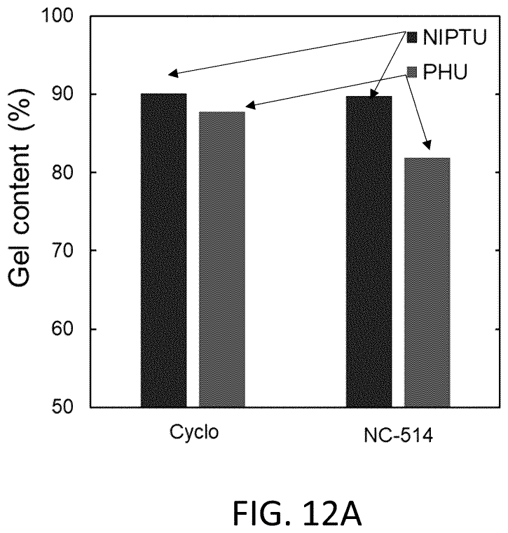

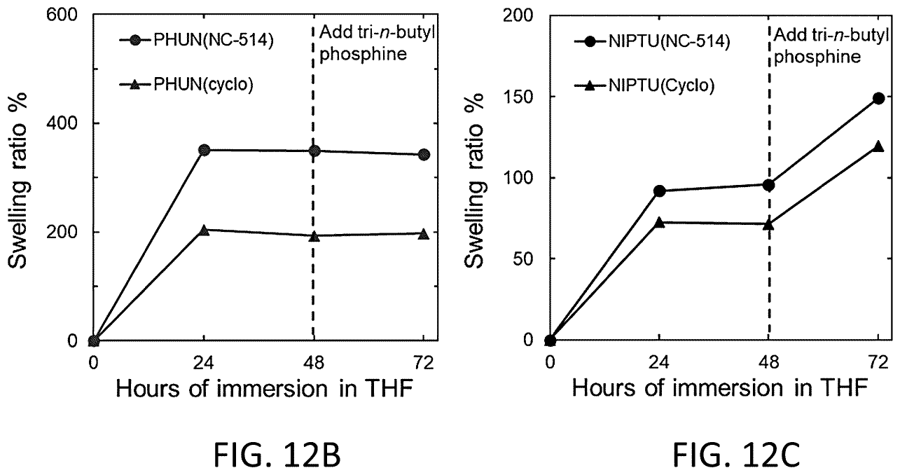

Swelling tests were performed for all synthesized NIPTU networks and PHU analogs. An equilibrium swelling ratio was observed for each sample within 48 h of swelling in THF. PHU(Cyclo) and PHU(NC-514) exhibited equilibrium swelling ratios of 198% and 351%, respectively. In contrast, NIPTU(Cyclo) and NIPTU(NC-514) exhibited equilibrium swelling ratios of 72% and 94%, respectively. (See FIGS. 12A-12C.) The significantly lower swelling ratios of NIPTU networks indicated higher crosslink densities than those in the corresponding PHU analogs, which will be further supported by mechanical characterization in the following sections. Gel content was measured for all samples as shown in FIGS. 12A-12C, in qualitative agreement with the swelling ratio results.

After all samples reached their equilibrium THF swelling ratios, an excess amount of tri-n-butylphosphine was added to the THF, and the samples continued to be swelled for another 24 h. Neither of the PHU analogs exhibited any change in swelling ratio. In contrast, as a result of the tri-n-butylphosphine addition, NIPTU(Cyclo) experienced an increase in swelling ratio from 72% to 119% and NIPTU(NC-514) from 94% to 149%. (See FIG. 12C.) These swelling test results added a chemical proof to the existence of disulfide crosslinks in NIPTU networks, which aligns with the observations from FTIR characterization.

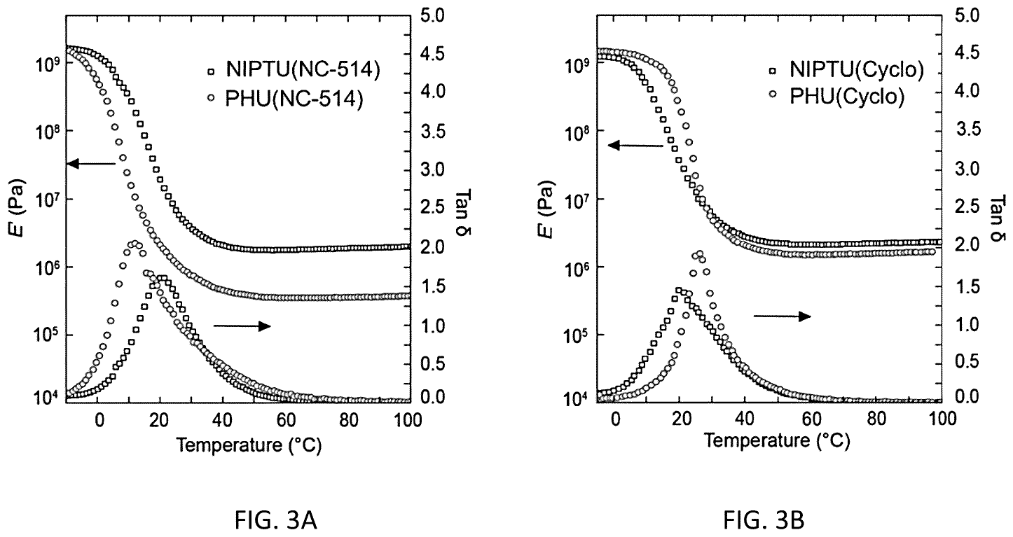

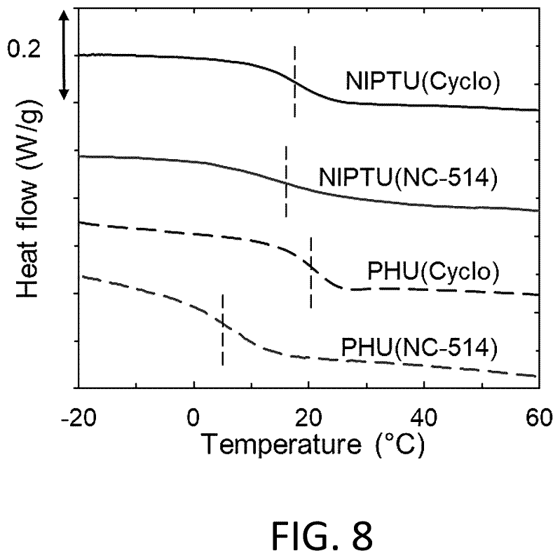

Biobased NIPTU Networks with Thionourethane and Disulfide Crosslinks and Their Analogous PHU Networks: Comparisons of Mechanical Properties and Water Sorption. The dynamic mechanical properties of the biobased NIPTU networks and their PHU analogs were examined and compared. See FIGS. 3A-3B. Below their DSC-determined glass transition temperatures (T_{g}s) (see FIG. 8 and Table 1), all NIPTU networks and PHU analogs showed glassy response, with tensile storage modulus (E′) values near or exceeding 1.0 GPa. The presence of the glass transition was also confirmed by the presence of a tan δ peak for each sample, with tan δ peak temperatures and T_{g}s obtained by DSC being in relatively close agreement. With increasing temperature in the rubbery state above T_{g}, each NIPTU network exhibited a rubbery plateau with storage modulus (E′) exceeding 1.0 MPa, consistent with a well-crosslinked network nature. Each analogous PHU network also showed a rubbery plateau response above T_{g}, consistent with the crosslinked nature of network materials. Importantly, NIPTU(NC-514) exhibited a much higher rubbery plateau E′ than PHU(NC-514) at 80° C., the value of the rubbery plateau E′ of NIPTU(NC-514) was 4.8 times that of PHU(NC-514). See Table 1. According to Flory's ideal rubber elasticity theory, the rubbery plateau modulus of a network is proportional to the density of crosslinks that participate in the network. (Imbernon, L. et al., Polym. Chem. 2015, 6, 4271-4278.) Thus, NIPTU(NC-514) had a network crosslink density that was 4.8 times that of its PHU analog. NIPTU(Cyclo) also exhibited a rubbery plateau E′ value and thus network crosslink density that exceed those of its PHU analog, with the two values at 80° C. differing by a factor of 1.2. This higher rubbery plateau E′ increment for the NC-514-based NIPTU/PHU pair relative to the Cyclo-based pair can be partially attributed to the slightly lower conversion of NC-514-CC as discussed in the previous paragraph.

TABLE 1
Glass transition temperature (T_{g}), storage modulus (E′) at 80°
C. of 1^{st} mold, and room-T tensile properties of NIPTU networks and analogous PHU
networks. All T_{g}s are reported as half-ΔCₚ T_{g}.

| | | E′ at | Young's | Tensile | Elongation |
|---|---|---|---|---|---|
| Sample | T_{g} (° C.) | 80° C. (MPa) | modulus (MPa) | strength (MPa) | at break (%) |
| NIPTU(NC-514) | 16 | 1.8 ± 0.3 | 10.1 ± 2.8 | 1.8 ± 0.2 | 128 ± 8 |
| PHU(NC-514) | 6 | 0.38 ± 0.02 | 4.0 ± 1.4 | 1.5 ± 0.1 | 239 ± 17 |
| NIPTU(Cyclo) | 17 | 2.2 ± 0.2 | 8.1 ± 1.5 | 3.1 ± 0.3 | 163 ± 24 |
| PHU(Cyclo) | 21 | 1.8 ± 0.1 | 6.6 ± 0.6 | 1.6 ± 0.1 | 127 ± 5 |

The significant increase in rubbery plateau modulus and thus network crosslink density in the NIPTU networks relative to their PHU analogs arose from two factors. First, the low reactivity of CC led to some unreacted residues in analogous PHU networks even after 14 h of reaction to gelation and an additional 3 days of curing at 80° C., resulting in lower crosslink density. In contrast, with substantially increased reactivities, the DTCs were completely reacted within experimental uncertainty during NIPTU synthesis and post-curing, as indicated by the absence of residual DTC FTIR signals associated with unreacted functional groups. Second, the inter-chain disulfide crosslinks that were present in the NIPTU networks but absent in the PHU analogs contributed to the higher crosslink density in the NIPTU networks. Thus, if one is preparing non-isocyanate-based PU networks, NIPTU networks are better choices than PHU networks based on both reactivity and mechanical properties reflecting crosslink density. Furthermore, in the case of the NC-514-based materials, NIPTU networks may be much better choices than the analogous PHU networks.

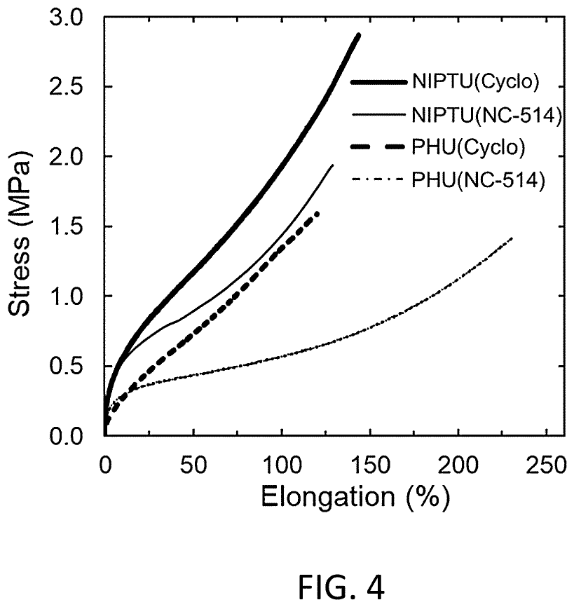

The tensile properties of NIPTU networks were also compared with those of their PHU analogs. FIG. 4 shows tensile stress-elongation curves, which are consistent with polymer networks at 5-20° C. above their T_{g}s. The tensile moduli of NIPTU(NC-514) and NIPTU(Cyclo) exceeded those of their PHU analogs by ˜150% and ˜25%, respectively. Similarly, the tensile strengths of NIPTU(NC-514) and NIPTU(Cyclo) exceeded those of their PHU analogs by ˜20% and ˜95%, respectively. (See Table 1.) The tensile property characterization was in qualitative agreement with the DMA characterization described above: the NIPTU networks, which contained both thionourethane and disulfide crosslinks, exhibited enhanced mechanical properties and crosslink densities relative to their PHU analogs, which contained only hydroxyurethane crosslinks.

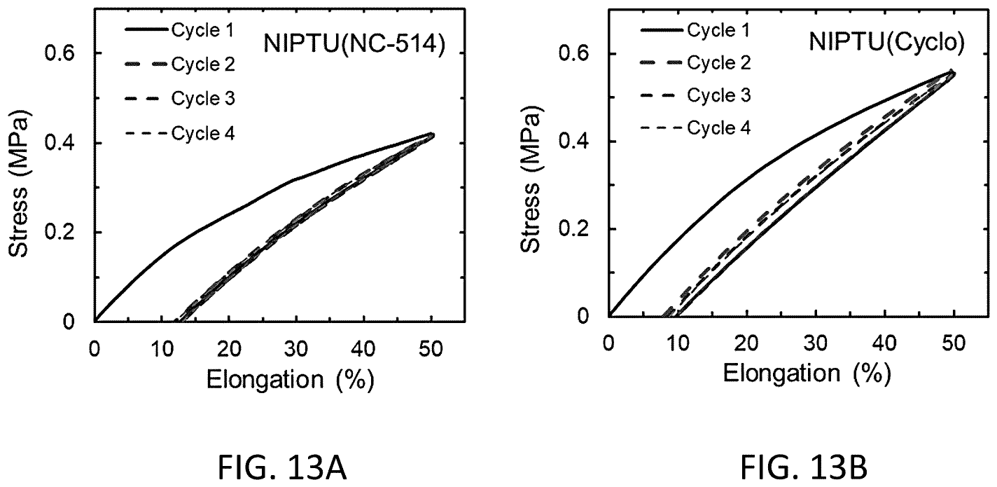

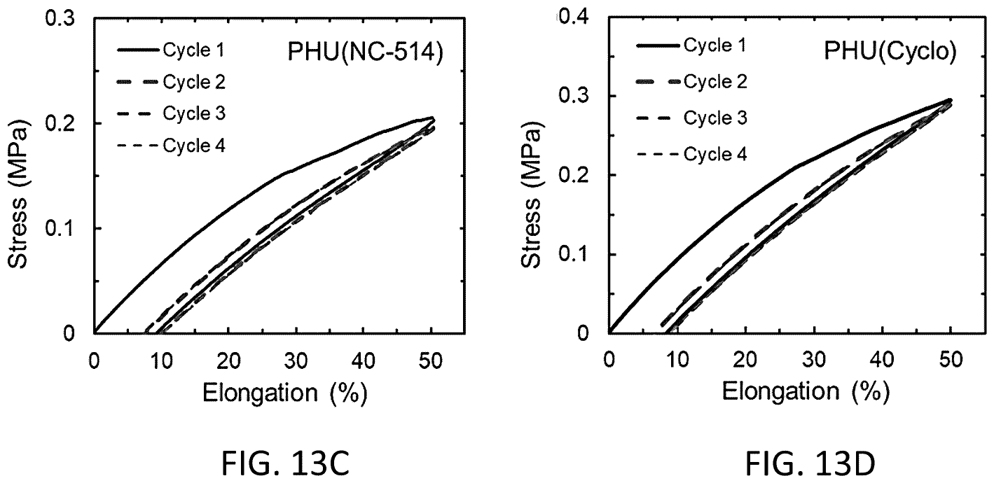

Tensile hysteresis was also characterized for both NIPTU networks and PHU analogs. As shown in FIGS. 13A-13D, the NIPTU networks and PHU analogs exhibited qualitatively similar load-unload cycles. Significant energy dissipation was evident in cycle 1, whereas cycles 2 to 4 exhibited similarly small energy dissipation. Notably larger energy dissipation occurred in cycle 1 for NIPTU networks than for PHU analogs. (Table S1.) The cleavage of disulfide bonds can significantly dissipate energy from elastic deformation. Thus, the larger energy dissipation in NIPTU networks in cycle 1 may be attributed to the additional disulfide crosslinks in those networks.

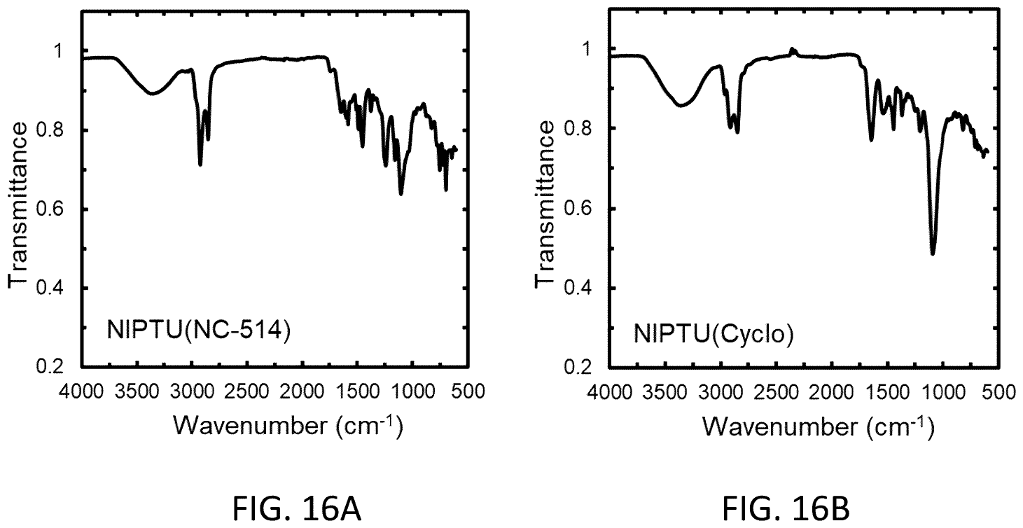

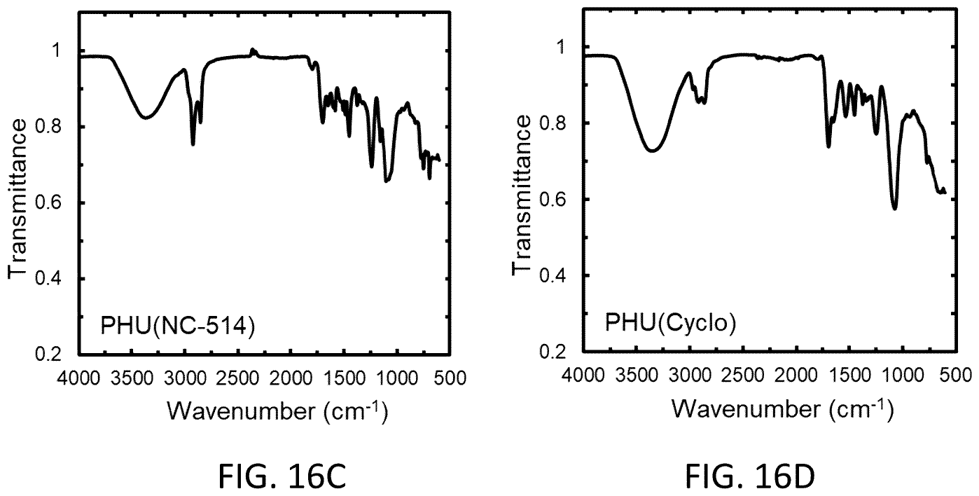

Because of the presence of substantial levels of hydroxyl groups, PHUs can exhibit hydrophilicity and poor moisture or water resistance. Here, the water uptake of the NIPTU networks and their PHU analogs was reported. Sample specimens of NIPTU networks and PHU analogs were immersed into deionized water for 24-72 h before the samples were weighed. FTIR characterization was performed on all samples after immersion. As shown in FIGS. 16A-16D, each sample exhibited a larger O-H peak at ˜3325 cm⁻¹ due to water sorption. After 24-72 h, NIPTU(Cyclo) and PHU(Cyclo) exhibited water sorption of ˜7 wt % and ˜20 wt %, respectively. Similarly, NIPTU(NC-514) and PHU(NC-514) exhibited water sorption of ˜δ wt % and ˜27 wt %, respectively. (See Table 2.) The roughly factor of 3 increase in water sorption in the PHU analogs relative to the NIPTU networks was mainly due to the hydrophilic nature of the hydroxyl groups present at substantial levels in the analogous PHU networks. The higher crosslink density in the NIPTU networks may also be expected to suppress water sorption.

TABLE 2
Water sorption of NIPTU networks and PHU
analogs after immersion in room-T water.

| | Immersion | Water | | Immersion | Water |
|---|---|---|---|---|---|
| Sample | time (h) | sorption wt % | Sample | time (h) | sorption wt % |
| | 24 | 7.3 ± 0.6 | NIPTU(Cyclo) | 24 | 6.7 ± 0.2 |
| NIPTU(NC-514) | 48 | 7.9 ± 0.4 | | 48 | 7.1 ± 1.1 |
| | 72 | 8.2 ± 0.7 | | 72 | 7.5 ± 0.4 |
| PHU(NC-514) | 24 | 25.9 ± 0.9 | PHU(Cyclo) | 24 | 19.5 ± 1.4 |
| | 48 | 26.5 ± 0.7 | | 48 | 20.5 ± 0.8 |
| | 72 | 27.4 ± 1.2 | | 72 | 20.8 ± 1.2 |

Conventional PU and polyurea are widely used in the coating industry in part for their water and chemical resistance. The NIPTU networks show water resistance (˜7 wt % sorption at equilibrium) that is comparable with some water-resisting conventional PUs and polyurea (5-16 wt % sorption at equilibrium) and surpasses some biobased PUs. (Dacuan, C. N. et al.,. Civil Eng. Archit. 2021, 9, 721-736; Agnol, L. et al., Prog. Org. Coat. 2021, 154, 106156; Kairytė, A. et al., Materials 2021, 14, 5475; Mokhothu, T. H. et al., Sci. Rep. 2017, 7, 13335; Hsieh, C. et al., J. Clean. Prod. 2020, 276, 124203; Chen, S. et al., Eur. Polym. J. 2021, 142, 110114.) Thus, some NIPTU networks may be good choices as non-isocyanate-based substitutes for water-resistant PU coatings.

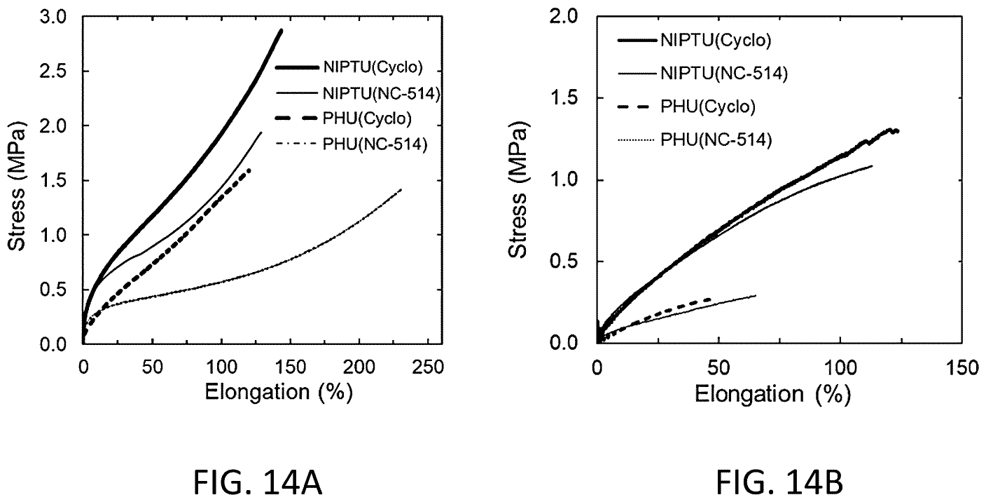

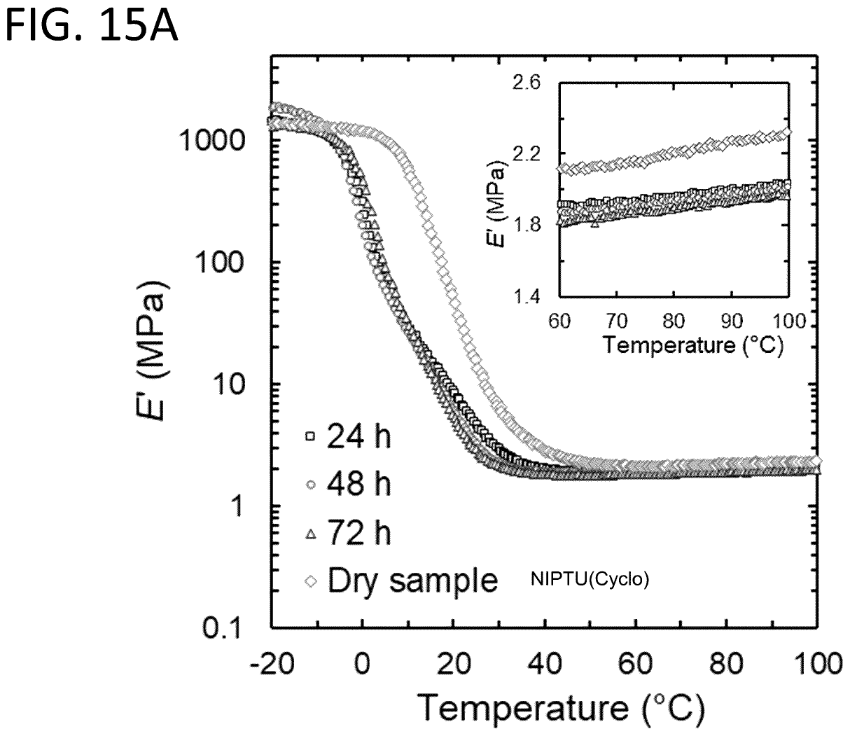

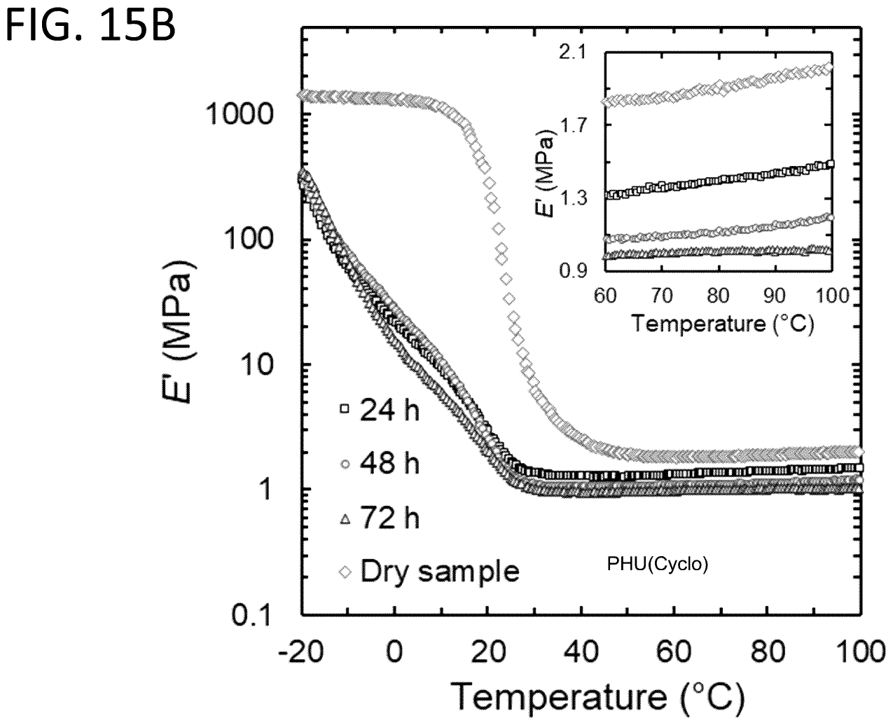

To illustrate the effect of reduced water sorption in NIPTU networks relative to PHU analogs on mechanical properties, DMA experiments were performed on the Cyclo-based NIPTU/PHU pair. Comparisons before and after long-term water immersion (Table S2 and FIGS. 15A-15B) revealed that NIPTU(Cyclo) exhibited at most a ˜10% reduction in the E′ (80° C.) value and PHU(Cyclo) as much as a ˜50% reduction. At room temperature, PHU(Cyclo) underwent a ˜90% reduction in E′ and NIPTU(Cyclo) underwent a ˜60% reduction in E′ after 24 h of water immersion. Tensile properties of NIPTU networks and PHU analogs after 72 h of water immersion were also evaluated. As shown in FIGS. 14A-14B, the NIPTU networks exhibited ˜60% reductions in the Young's modulus and 40-55% reductions in tensile strength due to the small amount of water sorption. In contrast, the PHU analogs exhibited significantly greater property losses after water sorption, including ˜85% reductions in the Young's modulus and ˜80% reductions in tensile strength. (See Table S3.) Relative to the NIPTU networks, considerably greater reductions in elongation at break were also observed in the PHU analogs. Thus, in addition to factors associated with reactivity and mechanical properties, the impact of water sorption on properties can strongly favor the selection of NIPTU networks over PHU networks for some applications, e.g., water-resistant coatings.

Reprocessability of Biobased NIPTU Networks with Thionourethane and Disulfide Crosslinks. To the best of the inventors' knowledge, only two studies have been reported on the reprocessability of NIPTU networks. Both studies were based on NIPTUs with linear backbones that were crosslinked only with disulfide linkages resulting from auto-oxidation of thiol groups. (Liu, W. et al., 2022; Ge, W. et al., 2021.) Here, the first results regarding the reprocessability of NIPTU networks containing both thionourethane and disulfide crosslinks are presented. These biobased NIPTU networks were synthesized at stoichiometric balance.

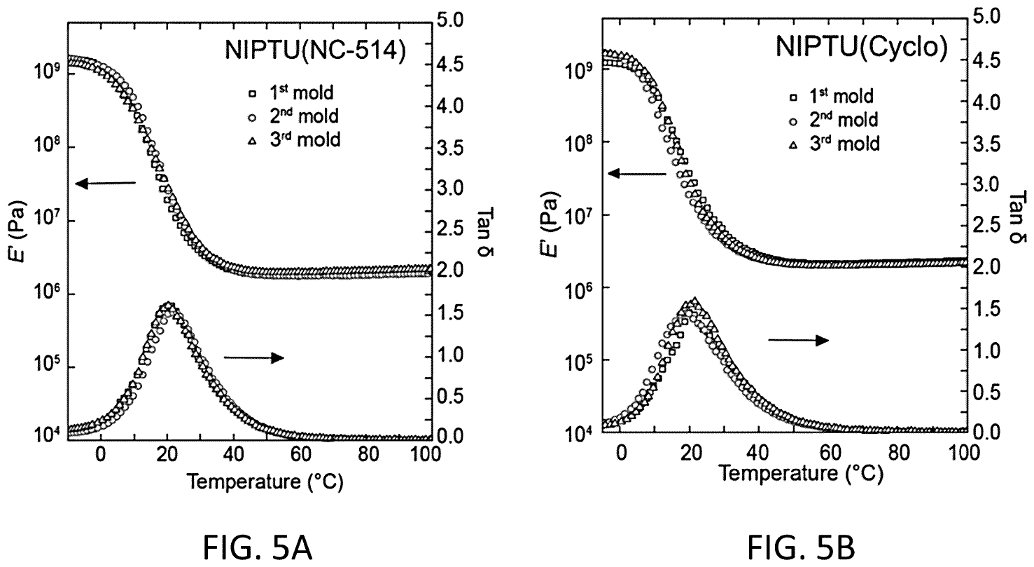

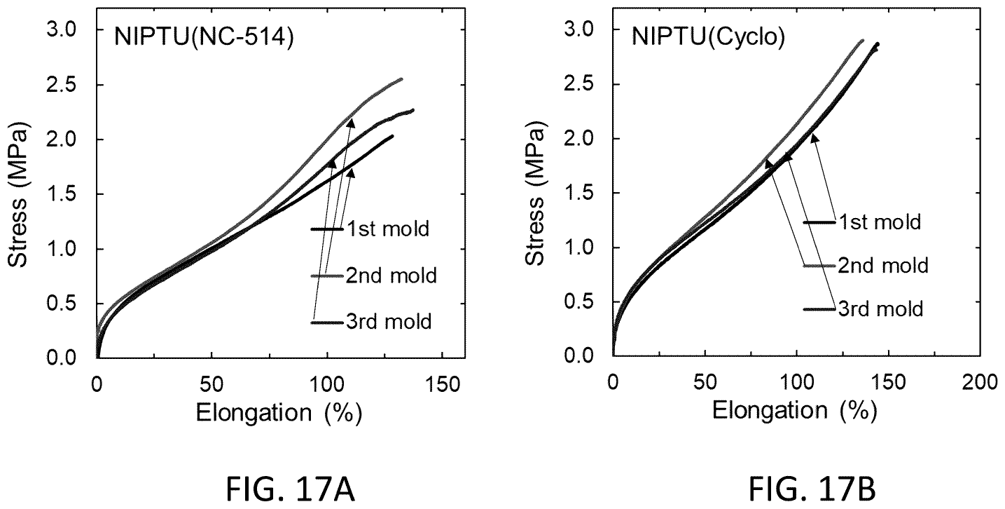

Reprocessing of NIPTU(NC-514) and NIPTU(Cyclo) was done by cutting samples into small pieces and compressing them into ˜0.7 mm thick sheets at 140° C. with a 7-ton ram force for three cycles. The recovery of crosslink density after reprocessing was evaluated using DMA. As shown in FIGS. 5A-5B, both NIPTU networks showed excellent reproduction of rubbery plateau storage modulus across three molding cycles. For each NIPTU network, the E′ values at 80° C. for the three molding cycles were identical within error. See Table 3. According to Flory's ideal rubber elasticity theory, these results demonstrate that the NIPTU networks exhibit full recovery of crosslink density after reprocessing within experimental uncertainty. (Flory, P. J. Principles of Polymer Chemistry. Cornell University Press: 1953.) (See Table 3 for values of crosslink density determined in accord with ideal rubbery elasticity.) The tan δ peak temperatures and values evident in FIGS. 5A-5B also exhibited little or no change with reprocessing, consistent with little or no change in glass transition behavior. Tensile tests were also performed to determine whether reprocessing of NIPTU networks affects large-deformation mechanical properties. Within experimental error, both NIPTU(Cyclo) and NIPTU(NC-514) maintained their tensile properties across three molding steps. (See FIGS. 17A-17B and Table S4.) These results quantified the excellent recovery after reprocessing of crosslink density and other properties of NIPTU networks that contain both thionourethane and disulfide crosslinks. Importantly, these results also indicate that materials derived from biowaste, such as cashew nutshells or rice husks, can result in robust properties while contributing to sustainability in two ways-(1) the renewable nature of the starting materials, and (2) reprocessability with full property recovery of the products.

TABLE 3
Storage modulus (E′) at 80° C. of NIPTU networks
as a function of molding cycles. Crosslink density (νₑ)
was calculated based on corresponding E′ at 80° C.*

| | Molding | E′ at | |
|---|---|---|---|
| Sample | cycles | 80° C. (MPa) | νₑ (mol · cm⁻³) |
| NIPTU(NC-514) | 1st | 1.8 ± 0.3 | (2.0 ± 0.3) × 10⁻⁴ |
| | 2nd | 1.8 ± 0.2 | (2.0 ± 0.2) × 10⁻⁴ |
| | 3rd | 2.0 ± 0.3 | (2.3 ± 0.3) × 10⁻⁴ |
| NIPTU(Cyclo) | 1st | 2.2 ± 0.2 | (2.5 ± 0.2) × 10⁻⁴ |
| | 2nd | 2.2 ± 0.1 | (2.5 ± 0.1) × 10⁻⁴ |
| | 3rd | 2.1 ± 0.1 | (2.4 ± 0.1) × 10⁻⁴ |

*Assuming Flory's ideal rubber elasticity theory when calculating crosslink density.

The reprocessability of NIPTU networks was demonstrated with networks that were synthesized at stoichiometric balance. Stoichiometric balance is important in achieving the highest possible conversion of functional groups which in turn is needed for the most robust network structure formation. In contrast, studies have indicated that reprocessability with full crosslink density recovery is achievable in some conventional PTU and PU networks only by synthesizing the networks slightly off stoichiometry with excess thiol or hydroxyl groups or via the use of complex/expensive catalysts. (Chen, X. et al., ACS Appl. Polym. Mater. 2020, 2, 2093-2101; Li L. et al., Macromolecules 2019, 52, 8207-8216; Fortman, D. J. et al., Macromolecules 2019, 52, 6330-6335; Khan, A. et al., Green Chem. 2021, 23, 4771-4779.) The facile reprocessability of NIPTU networks demonstrated here suggests that NIPTU networks may be viewed a good choice as sustainable substitutes for conventional PU networks and PTU networks even without regard to the presence or absence of isocyanate-based chemistry.

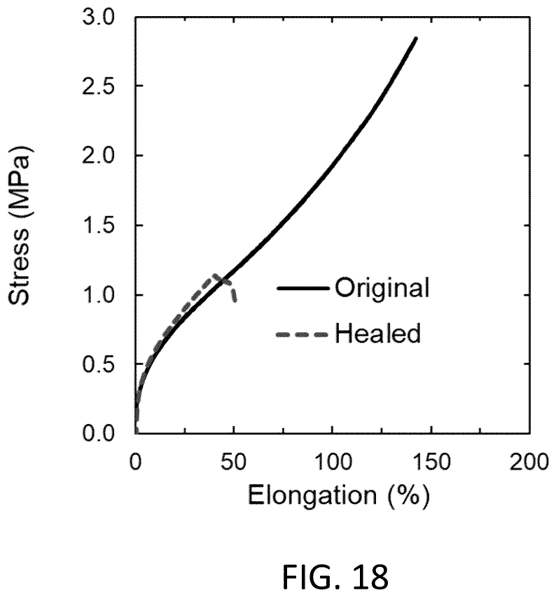

To the best of the inventors' knowledge, no prior study has considered the self-healing properties of NIPTU networks with both disulfide and thionourethane crosslinks. This Example provides an initial demonstration of the latter using NIPTU(Cyclo). After being cut and then healed at 120° C. for 6 h, the healed NIPTU(Cyclo) was able to withstand a load of ˜120 g. Tensile tests revealed that, relative to the original NIPTU(Cyclo) sample (sec Table 1), the healed NIPTU(Cyclo) had a similar Young's modulus (9.7 MPa) but broke at a significantly lower elongation. (See FIG. 18.) These results indicate that NIPTU(Cyclo) experienced partial healing.

Creep Resistance of Biobased NIPTU Networks with Thionourethane and Disulfide Crosslinks. Creep is the continuous and permanent deformation of a solid during exposure to mechanical stress. (Sperling, L. H. Introduction to Physical Polymer Science. John Wiley & Sons, Hoboken, United States, 2006.)

To the best of the inventors' knowledge, no prior study has reported on the creep response of NIPTU networks. Here, the creep resistance of the biobased NIPTU networks containing thionourethane and disulfide crosslinks was assessed. Shear creep experiments were conducted under a constant stress of 3.0 kPa at temperatures ranging from 60° C. to 140° C., far above the T_{g}s of the biobased NIPTU networks and, at 140° C., equaling the reprocessing temperature but at atmospheric pressure. The absolute strain was monitored as a function of time for 40000 s of deformation, after which the stress was removed and the strain recovery was measured for 10000 s.

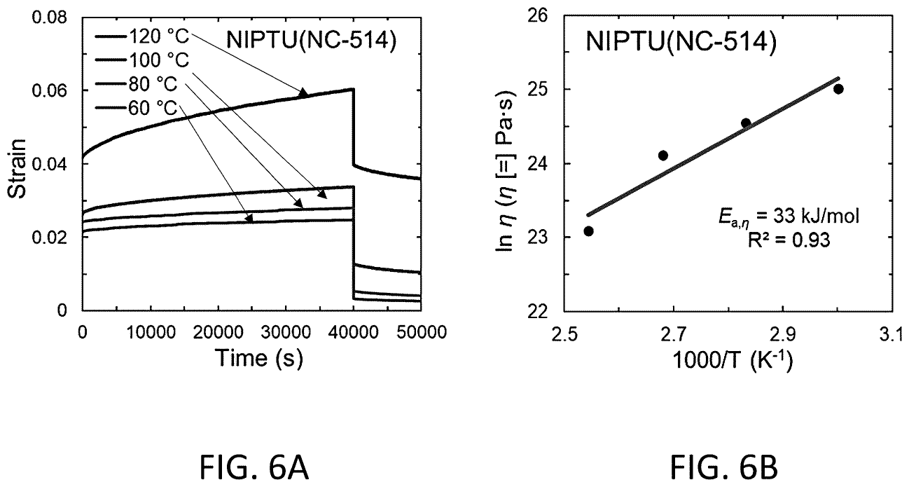

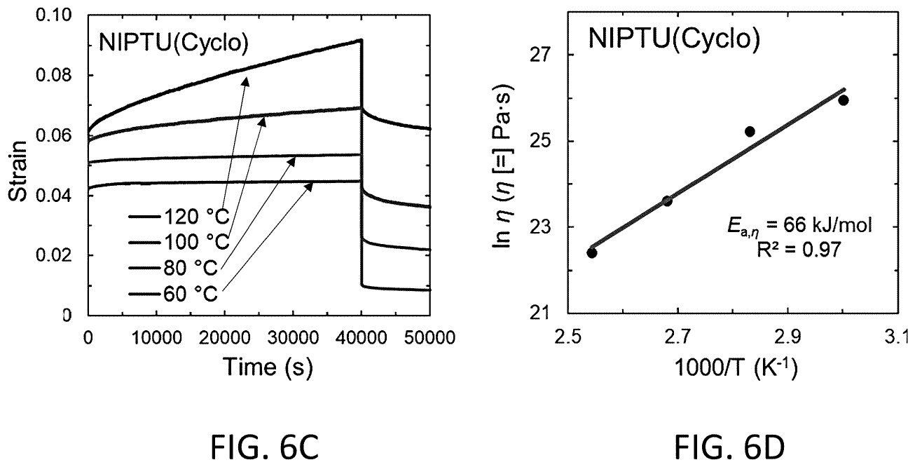

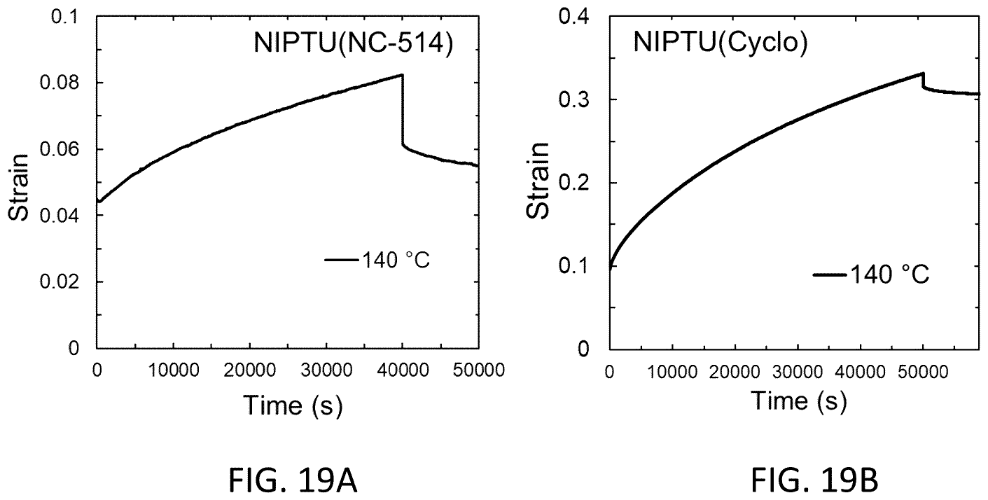

FIG. 6A shows that NIPTU(NC-514) exhibited barely discernable creep strain at temperatures up to 100° C. The creep strain, taken here as the strain accumulated between 3000 s and 40000 s, was 0.0032 and 0.0055 at 80° C. and 100° C., respectively. (See Table 4.) Notably, in comparison with results at 100° C., NIPTU(NC-514) exhibited nearly a factor of 3 increase in creep strain at 120° C. Upon removal of stress after 40000 s deformation at 80° C., the NIPTU(NC-514) recovered 86% of the total strain. The creep behavior of NIPTU(Cyclo) was also evaluated under identical conditions. At all temperatures tested, NIPTU(Cyclo) exhibited greater instantaneous (elastic) strain than NIPTU(NC-514). However, NIPTU(Cyclo) exhibited less creep strain than NIPTU(NC-514) at 60° C. and 80° C. but greater creep strain at 100° C. and 120° C. (See FIGS. 19A-19B for the creep results at 140° C. showing that both NIPTU networks exhibited substantial elastic strain and creep strain.) These results demonstrate that the combination of thionourethane and disulfide crosslinks yields a dynamic NIPTU network structure that provides for reprocessability at 140° C. but is resistant to creep (with creep strain <0.006) up to 80° C. and 100° C. for NIPTU(Cyclo) and NIPTU(NC-514), respectively.

The differences in elastic strain and creep strain between the two NIPTU networks cannot be explained by substantial differences in crosslink density. Indeed, Table 3 shows that within experimental error (±5-15%), there is no significant difference in the E′ (80° C.) values for the two NIPTU networks and thus no significant difference in crosslink density.

However, there is a significant difference in the apparent activation energies associated with viscous creep for the two NIPTU networks. The viscous strain rate was evaluated from the linear portions of the strain vs. time plots in FIGS. 6A and 6C. (Quantitative linearity was present at timescales between 26000 s and 40000 s for all data in FIGS. 6A and 6C. Quantitative linearity was not observed even at the longest timescales employed at 140° C.; see FIGS. 19A-19B.) For the temperature range from 60° C. to 120° C., values of the temperature-dependent creep viscosity, η, were obtained from the ratios of applied shear stress to viscous strain rate. See Table 4. Arrhenius plots of ln(η) as a function of inverse temperature provided for calculating the apparent creep viscosity activation energy (E_{a,η}) for each of the NIPTU networks. See FIGS. 6B and 6D. NIPTU(Cyclo) had an E_{a,η} value that was twice that of NIPTU(NC-514). This major difference in creep viscosity activation energy was consistent with the notion that, in the presence significant levels of associative dynamic chemistry, both the matrix viscoelasticity and polarity may play important roles in the temperature dependence of CAN creep response.

TABLE 4
Creep viscosity (η), creep strain (Δε), strain recovery,
and residual strain of NIPTU networks at different temperatures
under a constant shear creep stress of 3 kPa.

| | | | | Instant | | |
|---|---|---|---|---|---|---|
| | | | | strain | Total strain | |
| | | | | recovery^{c} | recovery^{d} | Residual |
| Sample | T (° C.) | η (Pa · s)^{a} | Δε^{b} | (%) | (%) | strain^{e} |
| NIPTU(NC- | 60 | 6.58 × 10¹⁰ | 0.0025 | 85 | 89 | 0.0027 |
| 514) | 80 | 4.34 × 10¹⁰ | 0.0032 | 80 | 86 | 0.0048 |
| | 100 | 2.92 × 10¹⁰ | 0.0055 | 62 | 69 | 0.011 |
| | 120 | 1.05 × 10¹⁰ | 0.015 | 34 | 40 | 0.036 |
| NIPTU(Cyclo) | 60 | 1.86 × 10¹¹ | 0.0013 | 74 | 81 | 0.0086 |
| | 80 | 8.42 × 10¹⁰ | 0.0019 | 48 | 59 | 0.022 |
| | 100 | 1.70 × 10¹⁰ | 0.0088 | 37 | 48 | 0.036 |
| | 120 | 5.26 × 10⁹ | 0.026 | 24 | 32 | 0.062 |

^{a}Creep viscosity (η) was calculated by dividing shear stress (3 kPa) by strain rate which was calculated from the slope of the creep curves between t = 26000 s and t = 40000 s.
^{b}Creep strain (Δε) was calculated as the difference in strain between t = 40000 s and t = 3000 s.
^{c}Percentage strain recovered measured 2 s after the stress was removed.
^{d}Percentage strain recovered measured 10000 s after the stress was removed.
^{e}Permanent strain that was not recovered within 10000 s after the stress was removed.

Regardless, the two NIPTU networks exhibited excellent creep resistance up to 80-100° C. The achievement of similar creep response has important implications. As detailed earlier, NIPTU networks and their PHU analogs exhibit significant differences in reactivity, mechanical properties, and water resistance, with the differences favoring the adoption of NIPTU networks for commercial use. Thus, when considering non-isocyanate substitutes for PU, creep performance does not change the conclusion that NIPTU networks have numerous advantages over PHU analogs for some commercial applications and that biobased NIPTU networks can yield robust properties.

### Conclusions

The inventors undertook the first study of non-isocyanate polythiourethane networks with both thionourethane and disulfide dynamic crosslinks to investigate the potential for reprocessability with full crosslink density recovery. This study is also the first to employ biobased NIPTU networks and to draw comparisons of mechanical properties, crosslink density, and water resistance as a function of the structural features of two distinct NIPTUs. The same comparison was made with biobased polyhydroxyurethane network analogs derived from structurally identical starting materials but with hydroxyurethane dynamic crosslinks and pendant hydroxyl groups instead of thionourethane and disulfide dynamic crosslinks. Tensile testing and results from dynamic mechanical analysis showed enhanced mechanical properties and crosslink densities in each NIPTU network relative to its PHU network analog. Likewise, each NIPTU network exhibited enhanced water resistance, as evidenced by a factor of ˜3 reductions in long-term water sorption in NIPTU networks relative to PHU networks. The advantages in mechanical properties and water resistance combined with the much higher reactivity of NIPTU chemistry mean that biobased NIPTU networks are favorable alternatives to PHU networks as non-isocyanate substitutes for conventional polyurethane and polythiourethane networks. Additionally, these NIPTU networks with thionourethane and disulfide crosslinks exhibited excellent reprocessability with full recovery of crosslink density after multiple reprocessing steps, potential as self-healing materials, and excellent creep resistance at temperatures up to 80-100° C. Thus, the NIPTU networks are not only renewable but also recyclable, and their crosslinks are robust at many tens of degrees above room temperature.

### Experimental Section

Synthesis and characterization of cyclic carbonates (CCs). Cyclo-CC and NC-514-CC were prepared as monomers to synthesize analogous PHU networks. Cyclo-CC was used as an example. In a specific synthesis, 10 grams of Cyclo (EEW=154 g/mol) was weighed in the test tube, followed by the addition of TBAI (10 mol % per epoxy group, 2.38 g) to the epoxy. The test tube was placed in an oil bath at 80° C. Then CO₂ was slowly purged into the epoxy with 15 mL DMF as solvent. After 80 h, the resulting viscous liquid was washed by ethylene acetate and brine solution before drying using a rotary evaporator at 60° C. and vacuum at 80° C. NC-514-CC was synthesized through the same procedure using the corresponding epoxy. The product from CC syntheses was examined by ¹H NMR and ¹³C NMR characterization.

The CC equivalent weight (CEW) of Cyclo-CC and NC-514-CC were characterized by ¹H NMR spectroscopy using 1,2,4,5-tetrachlorobenzene as internal reference. Using Cyclo-CC as an example, Cyclo-CC (64.1 mg) and 1,2,4,5-tetrachlorobenzene (34.1 mg) were dissolved in chloroform-d (CDCl₃). Three characteristic peaks of CC group (n, m, m′) and —CH of 1,2,4,5-tetrachlorobenzene (˜7.56 ppm) were integrated. The CEW of Cyclo-CC was calculated according to Eq. (1) as follows:

$$CEW ( \frac{g}{mol} ) = \frac{\frac{{I}_{ref}}{2} * {m}_{CC}}{{I}_{CC} * {n}_{ref}} \qquad ( 1 )$$

where I_{ref} is the peak intensity associated with the two protons on 1,2,4,5-tetrachlorobenzene (˜7.56 ppm), m_{CC} is the weight of Cyclo-CC added in the sample, I_{CC} is the average integration of the three characteristic peaks associated with the three protons on CC ring in Cyclo-CC, n_{ref} is the molar amount of 1,2,4,5-tetrachlorobenzene added in the sample. The calculated CEW of Cyclo-CC was 200 g/mol, which is very close to EEW of Cyclo plus the molar mass of CO₂ (154 +44 g/mol). Cyclo-CC: ¹H NMR (500 MHZ, CDCl₃): δ 4.88-4.71 (m, 2H), 4.50 (t, J=8.3 Hz, 2H), 4.40 (dd, J=8.3, 6.0 Hz, 2H), 3.67 (dd, J=11.0, 3.6 Hz, 2H), 3.59 (dd, J=11.1, 3.6 Hz, 2H), 3.32 (dd, J=6.4, 1.3 Hz, 2H), 2.05-1.71 (m, 4H), 1.59-1.48 (m, 2H), 1.10-0.85 (m, 4H). ¹³C NMR (126 MHZ, CDCl₃): δ 155.03, 77.67, 75.16, 69.91, 66.28, 38.01, 29.04.

Likewise, the CEW of NC-514-CC was calculated as 515 g/mol, which is very close to EEW of NC-514 plus the molar mass of CO₂ (470 +44 g/mol). NC-514-CC: 1H NMR (500 MHZ, CDCl₃): δ 7.21-7.12 (m, 2H), 6.94-6.81 (m, 2H), 6.77-6.62 (m, 4H), 5.10-4.95 (m, 2H), 4.72-4.57 (m, 2H), 4.57-4.48 (m, 3H), 4.32-4.18 (m, 2H), 4.17-4.07 (m, 2H), 2.65-2.45 (m, 4H), 1.63-1.55 (m, 4H), 1.32-1.15 (m, 21H), 0.98-0.82 (m, 3H). ¹³C NMR (126 MHZ, CDCl₃) δ 157.81, 154.69, 145.04, 129.45, 129.39, 122.20, 115.93, 114.96, 111.44, 74.14, 66.86, 66.29, 35.96, 33.98, 32.30-31.13 (m), 30.14-28.34 (m), 22.67, 15.95-13.09 (m).

Synthesis of PHU analogs by cyclic carbonate aminolysis. In a specific synthesis of PHU(Cyclo), Cyclo-CC (2.0 g, CEW=200 g/mol) was weighed in a 20 mL scintillation vial with 2 mL of DMF as solvent. T-403 (1.62 g, amine hydrogen equivalent weight=81 g/eq) and 5 mol % (3.1 wt %) per CC group of DMAP (61.0 mg) was also added into the vial. The mixture was then put under constant stirring for 1 minute for mixing. After mixing, the resulting mixture was put into an oil bath at 80° C. for 14 h. After 14 h, the resulting elastomeric solid was cut into small pieces and put under vacuum at 80° C. for 3 days to eliminate the solvents and for curing before characterization. PHU(NC-514) was synthesized through the same procedure using the corresponding CC (NC-514-CC, CEW=515 g/mol) and also 5 mol % DMAP (1.2 wt %) as catalyst. The product from PHU analog syntheses were examined by FTIR characterization.

Possible regioisomers from DTC synthesis. Potential outcomes of the DTC synthesis are shown in FIG. 1, with A being the main and desired product DTC. ¹³C NMR results of the synthesis product can be used to examine the existence of regioisomers B and C. Using the ¹³C NMR result of Cyclo-DTC as an example, product B can be eliminated because of the appearance of multiple peaks above 60 ppm. Generally, carbons with single covalent bonds to sulfur only but not oxygen, such as carbon 2 or 3, have chemical shifts no higher than 50 ppm. Thus, product B cannot be the main product. The appearance of 89 ppm peak (n) makes C unlikely to exist since only carbon 1 in A that is adjacent to an oxygen and only two bonds away from another oxygen can contribute such a high chemical shift.

Possible regioisomers from DTC synthesis, with A being the desired product DTC.

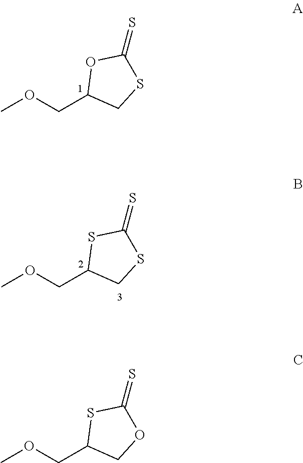

Check for residual solvent in NIPTU networks and PHU analogs. To investigate whether there are any amounts of solvent residues that will affect the macroscopic properties of NIPTU networks (THF, ethyl acetate) and PHU analogs (DMF, ethyl acetate), DSC experiments were performed on all samples. NIPTU networks were heated in the DSC from −30 to 100° C. for three cycles. (See FIG. 9A.) No noticeable changes in the glass transition region of NIPTU networks were observed across three cycles. PHU analogs were scanned from −30 to 190° C. for three cycles. Likewise, no discernible changes in the glass transition region of PHU analogs were observed across three cycles. (See FIG. 9B.) In addition, no distinguishable peak or bump on the first heating curves was observed around and above the boiling point of DMF. (See FIG. 9C.) These results suggest that the samples were substantially dried such that any solvent residues will not significantly affect the macroscopic properties of NIPTU networks and PHU analogs.

Effect of DBU catalyst concentration on the NIPTU network. Another batch of NIPTU(Cyclo) was synthesized using 3.6 mol % (2.4 wt %) DBU as catalyst, which is the same molar concentration as that for NIPTU(NC-514) reported above. As shown in FIG. 10, NIPTU(Cyclo) synthesized with 3.6 mol % (2.4 wt %) DBU and NIPTU(Cyclo) synthesized with 1.5 mol % (1 wt %) DBU, with the latter being reported in the manuscript, exhibited similar glass transition region and rubbery plateau modulus. This indicates that 1.5 mol % (1 wt %) DBU is sufficient to obtain NIPTU(Cyclo) with high conversion.

Effect of DMAP catalyst on PHU synthesis. DMAP was used in this example for the synthesis of PHU analogs because DMAP can assist the (re) processing of PHU. To investigate the potential effect of a different catalyst on the resulting PHU analogs, PHU(Cyclo) and PHU(NC-514) were synthesized with DBU as catalyst. As a result, PHU(NC-514) synthesized with DBU showed similar glass transition region and rubbery plateau modulus to its counterparts synthesized with DMAP. (FIG. 11A.) On the contrary, PHU(Cyclo) synthesized with DBU showed lower rubbery plateau modulus than its counterpart synthesized with DMAP. (FIG. 11B.) This rubbery plateau modulus difference might be attributed to the improved (re) processability when DMAP is used.

TABLE S1
Energy dissipation of NIPTU networks and PHU analogs during four
load and unload cycles. All data are reported in units of kJ/m³.

| Sample | Cycle 1 | Cycle 2 | Cycle 3 | Cycle 4 |
|---|---|---|---|---|
| NIPTU(Cyclo) | 51.3 | 11.2 | 7.1 | 6.6 |
| NIPTU(NC-514) | 44.6 | 3.4 | 3.2 | 3.5 |
| PHU(Cyclo) | 24.2 | 6.2 | 6.1 | 5.6 |
| PHU(NC-514) | 19.4 | 4.7 | 5.3 | 5.3 |

TABLE S2
Comparison of E′ at 25° C. and 80° C. between NIPTU(Cyclo)
and PHU(Cyclo) as functions of immersion time in water.

| | Immersion | E′ at | E′ at |
|---|---|---|---|
| Sample | time (h) | 25° C. (MPa) | 80° C. (MPa) |
| NIPTU(Cyclo) | Dry sample | 15 | 2.2 |
| | 24 | 5.8 | 2.0 |
| | 48 | 3.9 | 1.9 |
| | 72 | 3.3 | 1.9 |
| PHU(Cyclo) | Dry sample | 24 | 1.9 |
| | 24 | 2.1 | 1.4 |
| | 48 | 1.7 | 1.1 |
| | 72 | 1.6 | 1.0 |

TABLE S3
Comparison of tensile properties between NIPTU networks and
PHU analogs before and after water immersion for 72 h.

| | | Young's | Tensile | Elongation |
|---|---|---|---|---|
| | Sample | modulus | strength | at break |
| Sample | state | (MPa) | (MPa) | (%) |
| NIPTU(NC-514) | Dry | 10.1 ± 2.8 | 1.8 ± 0.2 | 128 ± 8 |
| | Immersed | 4.2 ± 0.3 | 1.1 ± 0.1 | 113 ± 11 |
| PHU(NC-514) | Dry | 4.0 ± 1.4 | 1.5 ± 0.1 | 239 ± 17 |
| | Immersed | 0.8 ± 0.1 | 0.3 ± 0.1 | 80 ± 18 |
| NIPTU(Cyclo) | Dry | 8.1 ± 1.5 | 3.1 ± 0.3 | 163 ± 24 |
| | Immersed | 3.1 ± 0.2 | 1.4 ± 0.2 | 131 ± 12 |
| PHU(Cyclo) | Dry | 6.6 ± 0.6 | 1.6 ± 0.1 | 127 ± 5 |
| | Immersed | 1.0 ± 0.2 | 0.3 ± 0.1 | 49 ± 12 |

TABLE S4
Room-temperature tensile properties of
1st, 2nd, and 3rd mold NIPTU networks.

| | | Young's | Tensile | Elongation |
|---|---|---|---|---|
| | Molding | modulus | strength | at break |
| Sample | steps | (MPa) | (MPa) | (%) |
| NIPTU(NC-514) | 1st | 10.1 ± 2.8 | 1.8 ± 0.2 | 128 ± 8 |
| | 2nd | 9.4 ± 1.5 | 2.3 ± 0.4 | 137 ± 15 |
| | 3rd | 9.3 ± 2.2 | 2.0 ± 0.1 | 149 ± 21 |
| NIPTU(Cyclo) | 1st | 8.1 ± 1.5 | 3.1 ± 0.3 | 163 ± 24 |
| | 2nd | 8.4 ± 0.3 | 2.9 ± 0.2 | 156 ± 10 |
| | 3rd | 8.4 ± 1.3 | 2.9 ± 0.1 | 146 ± 18 |

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A disulfide-crosslinked non-isocyanate polythiourethane network comprising a non-isocyanate polythiourethane network having a branched polythiourethane backbone and interchain disulfide crosslinks, wherein the disulfide-crosslinked non-isocyanate polythiourethane network is free of oxidizing agents that promote disulfide crosslink formation and the branched polythiourethane backbone is free of or substantially free of unreacted pendant thiol groups.

2. The disulfide-crosslinked non-isocyanate polythiourethane network of claim 1, wherein the branched polythiourethane backbone comprises R1 groups along the backbone chain and the R1 groups have one of the following chemical structures:

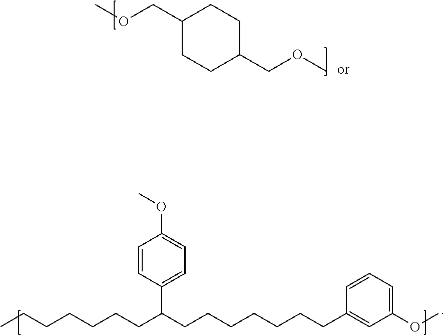

3. The disulfide-crosslinked non-isocyanate polythiourethane network of claim 1, wherein the disulfide-crosslinked non-isocyanate polythiourethane network is the reaction product of dithiocarbonate molecules having two or more cyclic 5-membered dithiocarbonate rings and branched polyalkylene glycol polyamine molecules.

4. The disulfide-crosslinked non-isocyanate polythiourethane network of claim 3, wherein the branched polyalkylene glycol polyamine molecules are branched polypropylene glycol triamine molecules.

5. A method of forming a disulfide-crosslinked non-isocyanate polythiourethane network, the method comprising:
reacting dithiocarbonate molecules having two or more cyclic 5-membered dithiocarbonate rings with polyamine molecules having three or more amine groups to form a crosslinked non-isocyanate polythiourethane network having a branched polythiourethane backbone and interchain disulfide crosslinks, wherein the reaction is carried out in the absence of oxidizing agents that promote disulfide crosslink formation, and further wherein the branched polythiourethane backbone is free of or substantially free of unreacted pendant thiol groups.

6. The method of claim 5, further comprising reacting epoxy molecules having two or more epoxy groups with carbon disulfide to form the dithiocarbonate molecules.

7. The method of claim 6, wherein the epoxy molecules are derived from a natural source.

8. The method of claim 5, wherein the dithiocarbonate molecules have the chemical structure:

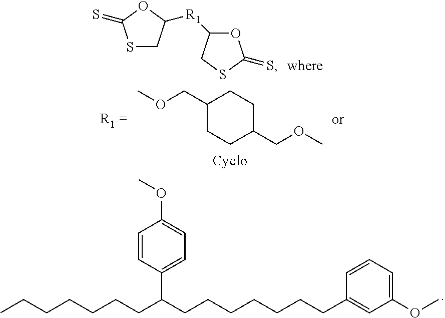

9. The method of claim 5, wherein the polyamine molecules are branched polyalkylene glycol polyamine molecules.

10. The method of claim 9, wherein the branched polyalkylene glycol polyamine molecules are branched poly (propylene glycol) triamine molecules.

11. The method of claim 5, wherein the reaction is carried out at a temperature in a range from 60° C. to 100° C.

12. A method of reprocessing disulfide-crosslinked non-isocyanate polythiourethane networks, the method comprising:
heating one or more pieces of a disulfide-crosslinked non-isocyanate polythiourethane network comprising a branched polythiourethane backbone and interchain disulfide crosslinks from a first temperature to a second temperature, wherein reversible disulfide linkage dissociation occurs to a greater extent at the second temperature than at the first temperature;
reshaping the one or more pieces of the disulfide-crosslinked non-isocyanate polythiourethane network at the second temperature to form a reshaped disulfide-crosslinked non-isocyanate polythiourethane network; and
cooling the reshaped disulfide-crosslinked non-isocyanate polythiourethane network to form a reprocessed disulfide-crosslinked non-isocyanate polythiourethane network.

13. The method of claim 12, wherein the crosslink density, the tensile storage modulus, or both, of the disulfide-crosslinked non-isocyanate polythiourethane network are the same before and after reprocessing.

14. The method of claim 12, wherein the first temperature is less than 100° C. and the second temperature is at least 120° C.

15. The method of claim 12, wherein the disulfide-crosslinked non-isocyanate polythiourethane network is the reaction product of dithiocarbonate molecules having two or more cyclic 5-membered dithiocarbonate rings and branched polyalkylene glycol polyamine molecules.

16. The method of claim 15, wherein the branched polyalkylene glycol polyamine molecules are branched polypropylene glycol triamine molecules.

17. The method of claim 12, wherein the disulfide-crosslinked non-isocyanate polythiourethane network is free of oxidizing agents that promote disulfide crosslink formation.

18. The method of claim 12, wherein the branched polythiourethane backbone comprises R1 groups along the backbone chain and the R1 groups have one of the following chemical structures: [chemical structure]
